(19) United States
(12) Patent Application Publication
(10) Pub. No.: US 2006/0160591 A1
(43) Pub. Date: Jul. 20, 2006

(54) Typing game apparatus

(75) Inventor: Junichi Kogo, Tokyo (JP)

Correspondence Address: SNIDER & ASSOCIATES, P. O. BOX 27613, WASHINGTON, DC, 20038-7613, US

(73) Assignee: ARUZE Corp., Tokyo (JP)

(21) Appl. No.: 11/327,473

(22) Filed: Jan. 9, 2006

(30) Foreign Application Priority Data
Jan. 14, 2005 (JP) 2005-007560
Feb. 9, 2005 (JP) 2005-033438

(51) Int. Cl. A63F 13/00

(52) U.S. Cl. 463/1

(57) ABSTRACT

A typing game apparatus has two display devices, making realistic and varied games possible. The configuration is such that two liquid crystal display devices are provided in the front face of a cabinet, and when a coin or the like is inserted into a coin slot and typing-game execution processing is performed, promotional video footage related to performed music is displayed on the second liquid crystal display device disposed towards the top of the cabinet, and, in parallel thereto, a main game screen, in which a character string corresponding to lyrics of the music is displayed, is displayed on the first liquid crystal display device disposed towards the bottom of the cabinet.

This application is based on and claims the benefit of priority from Japanese Patent Application No. 2005-033438, filed on Feb. 9, 2005, and Japanese Patent Application No. 2005-007560, filed on Jan. 14, 2005, the contents of which are incorporated herein by reference.

### BACKGROUND OF THE INVENTION

1. Field of the Invention

The present invention relates to typing game apparatuses in which a game is controlled based on a determination as to whether a character string input by a keyboard operation is correct or not, and in particular, to typing game apparatuses that make realistic and varied games possible by providing two display devices: a first display screen and a second display screen disposed above the first display screen.

Furthermore, the present invention relates to typing game apparatuses in which a game is controlled based on a determination as to whether a character string input by a keyboard operation is correct or not, and in particular, to typing game apparatuses that make realistic and varied games possible by providing two display screens: a first display screen and a second display screen disposed above the first display screen.

2. Related Art

Conventionally, in typing games carried out as practice for typing on a keyboard of a word processor or the like, by a player typing in a character string, displayed on a display device or the like, from the keyboard within a prescribed time, the player memorizes the key layout of the keyboard and learns to type efficiently. Devices for performing this type of typing game include cabinet-type typing game apparatuses placed in game centers and the like, which, by collecting a prescribed fee, allow usage by players from the general public, and typing game apparatuses formed by enabling games on an individual PC, by individual players purchasing software and installing a program on the PC.

For example, as a cabinet-type typing game apparatus, Japanese Patent Application, Laid Open No. 2003-62331 describes a typing game apparatus that raises entertainment value by giving a problem to a player via a display screen, determining whether a character string (including numerals and symbols) response to the problem, that the player inputs using a keyboard operation, is correct or not, and assigning a prescribed score.

Patent Document 1: Japanese Patent Application, Laid Open No. 2003-62331 (Pages 7 to 9, FIGS. 1 to 8).

### SUMMARY OF THE INVENTION

Problem to be Solved by the Invention

However, in the typing game apparatus described in the abovementioned patent document 1, all information concerning a game, including the problem characters of the problem given to the player, the character string that the player inputs by the keyboard, and the score and the like, obtained by the player, is displayed on one display device and disclosed to the player. Furthermore, in conventional typing game apparatuses, so that the player does not lose interest and to make the game exciting, auxiliary information such as a presentation and the like (for example, a video related to the input character string, or the like) is also displayed.

Here, information necessary for progressing with the game, including the problem text of the problem given to the player and the character string the player inputs via the keyboard, form the core of contents displayed on the display device during the game. That is, the auxiliary information used in the presentation or the like that is not essential for progressing with the game is only displayed in a corner area of the display screen at a level that does not interfere with the game, or during a standby state before the start or after the finish of the game. Accordingly, such presentation functions could not be adequately exhibited. Furthermore, by simultaneously displaying information necessary for progressing with the game and information related to the presentation, on one screen, there has been a concern that information necessary for the game itself would become difficult for the player to see, and concentration on the game would not be possible.

Furthermore, in the typing game apparatus described in the abovementioned patent document 1, all information concerning the game, including the problem text of the problem given to the player, the character string that the player inputs by the keyboard, and the score and the like obtained by the player, is displayed on one display device and is disclosed to the player. Furthermore, in the conventional typing game apparatuses, so that the player does not lose interest and to make the game exciting, auxiliary information such as a presentation or the like (for example, a video related to the input character string, or the like) is also displayed.

Here, information necessary for progressing with the game, including the problem text of the problem given to the player and the character string the player inputs via the keyboard, form the core of contents displayed on the display device during the game. That is, the auxiliary information used in the presentation or the like, that is not essential for progressing with the game, is only displayed in a corner area or the like of the display screen, or during a standby state before the start or after the finish of the game. Accordingly, such presentation functions could not be adequately exhibited. In this regard, by displaying information necessary for progressing with the game and information related to the presentation, without any particular intent, simultaneously on one screen, there has been a concern that this would interfere with the game, the information necessary for the game itself would become difficult for the player to see, and concentration on the game would not be possible.

Furthermore, for cases of games played on a PC in which a program has been installed, since there is a single display device for performing display, similar types of problems have occurred.

The present invention is directed to solving the abovementioned conventional problems, and has as an object the provision of a typing game apparatus that makes a wide diversity of games possible and enables a player to concentrate on the game, by arranging two display devices, that is, a first display screen and a second display screen, and using images respectively displayed thereon.

In addition, the present invention is directed to solving the abovementioned conventional problems, and has as an object the provision of a typing game apparatus that makes a wide diversity of games possible and enables a player to concentrate on the game, by arranging two display screens, that is, a first display screen and a second display screen, and using images respectively displayed thereon, and additionally, facilitates viewing display contents of the second display screen on the first display screen, without the player's concentration on the game being interfered with.

According to a first aspect of the present invention for realizing the abovementioned objects, a typing game apparatus includes an image display (for example, a first liquid crystal display device 3, a second liquid crystal display device 4) for displaying a prescribed image related to the game, an input device (for example, a keyboard 6) in which a plurality of keys corresponding to a plurality of characters is disposed, a CPU (for example, a CPU 51, step S28) for determining whether or not a character string inputted by the input device is in agreement with a prescribed character string (for example, lyrics of reproduced music), and for controlling the game, based on a judged result by the determining, in which the image display includes a first display screen (for example, the first liquid crystal display 3) and a second display screen (for example, the second liquid crystal display device 4) disposed above the first display screen.

Furthermore, in a second aspect of the typing game apparatus related to the first aspect of the present invention (for example, the typing game machine 1), the typing game apparatus includes a display controller (for example, the CPU 51, a display control circuit 60) for displaying game information (for example, a lyrics display area 22, a Roman letters display area 23) related to progress of the game, including the prescribed character string, on the first display screen (for example, the first liquid crystal display-device 3), and for displaying a presentation image (for example, promotional video footage 20) in which a game effect presentation is carried out in parallel with a display on the first display screen, on the second display screen (for example, the second liquid crystal display device 4).

Furthermore, in a third aspect of the typing game apparatus related to the second aspect of the present invention (for example, the typing game machine 1), the typing game apparatus includes a memory (for example, a hard disk drive (HDD) 55) for storing music data, and a sound controller (for example, the CPU 51, a sound control circuit 61) for performing music at a specified tempo together with outputting voice, based on the music data stored in the tune data storage device, in which the display controller (for example, the CPU 51, the display control circuit 60) displays, as the prescribed character string, a character string related to the voice output by the sound controller, on the first display screen (for example, the first liquid crystal display device 3), and also the presentation image (for example, the promotional video footage 20) related to the music in accompaniment with progress of the music performance of the sound controller, on the second display screen (for example, the second liquid crystal display device 4).

Furthermore, in a fourth aspect of the typing game apparatus related to the third aspect of the present invention (for example, the typing game machine 1), the presentation image related to the music (for example, the promotional video footage 20) is a promotional video.

Furthermore, in a fifth aspect of the present invention, the typing game apparatus (for example, a typing game machine 1) includes an image display (for example, a first liquid crystal display device 1003, a second liquid crystal display device 1004) for displaying a prescribed image related to the game, an input device (for example, a keyboard 6) on which is disposed a plurality of keys corresponding to a plurality of characters, an CPU (for example, a CPU 51, step S28) for determining whether or not a character string input by the input device is in agreement with a prescribed character string, and for controlling the game based on a judged result by the determining, the image display having a first display screen (for example, the first liquid crystal display device 1003) and a second display screen (for example, the second liquid crystal display device 1004) disposed above the first display screen, a display controller (for example, the CPU 51, a display control circuit 60) for displaying game information (for example, a lyrics display area 1022, a Roman letters display area 1023) related to progress of the game, including the prescribed character string, on the first display screen, and also an effect presentation image (for example, promotional video footage 20), in which a game presentation is carried out in parallel with a display on the first display screen, on the second display screen, the display controller (for example, the CPU 51, the display control circuit 60, step S22, step S23) secures an independent image area (for example, an independent image area 1101) in an upper central region of the first display screen, and displays a presentation image identical to a presentation image displayed on the second display screen, in the independent image-area.

Furthermore, in a sixth aspect of the typing game apparatus related to the fifth aspect of the present invention (for example, the typing game machine 1), the typing game apparatus has a memory (for example, a HDD 55) for storing music data, and a sound controller (for example, the CPU 51, a sound control circuit 61) for performing music at a specified tempo together with outputting voice, based on the music data stored in the tune data storage device, the display controller (for example, the CPU 51, the display control circuit 60) displaying, as the prescribed character string, a character string related to the voice outputted by the sound controller, on the first display screen (for example, the first liquid crystal display device 1003), and also displaying an effect presentation image (for example, the promotional video footage 20) related to the music in accompaniment with the progress of the music performance of the sound controller, on the second display screen (for example, the second liquid crystal display device 1004).

Furthermore, in a seventh aspect of the typing game apparatus related to the sixth aspect of the present invention (for example, the typing game machine 1), the presentation image related to the music (for example, the promotional video footage 20) is a promotional video.

Effects of the Invention

Since the typing game apparatus according to the first aspect of the present invention has, as the image display for displaying the prescribed image related to the game, the first display screen and the second display screen disposed above the first display screen, compared to cases in which only one image display is used, it is possible to provide a wide variety of typing games using images displayed respectively on the two image displays. Accordingly, a player playing the typing game does not lose interest, and enthusiasm for the game can be increased.

Furthermore, in the typing game apparatus according to the second aspect of the present invention, since the game information related to the progress of the game, including the prescribed character string, is displayed on the first display screen, and the effect presentation image in which a game presentation is carried out, in parallel with a display on the first display screen, on the second display screen, it is possible to display the effect presentation image that is not directly necessary for progressing with the game on a display device separate from the game information that is necessary for progressing with the game. Accordingly, the player can easily perceive necessary information and can concentrate when playing the game. Furthermore, by displaying the effect presentation image using an independent image display, typing games with a realistic feel not existing heretofore are possible and the player does not lose interest.

Furthermore, in the typing game apparatus according to the third aspect of the present invention, since voice and music at a specified tempo are outputted based on the stored music data, the character string related to the outputted voice is displayed on the first display screen as the prescribed character string, and the effect presentation image related to the music is displayed on the second display screen, a typing game in which typing is carried out in accompaniment with the performed music is possible, and the effect presentation image related to the music, not directly necessary for progressing with the game can be displayed by the display device separately from the character string related to the voice necessary for progressing with the game. Accordingly, the player can easily perceive necessary information and can concentrate on the game. Furthermore, by displayed the effect presentation image related to the music using an independent image display, a typing game with performance of music and also a realistic feel not existing heretofore is possible, so that the player does not lose interest.

Moreover, in the typing game apparatus according to the fourth aspect of the present invention, since the promotional video is used as the presentation image related to the music, a typing game with a realistic feel is possible, in which the form of a singing artist is displayed together with the performance of the music, so that the player does not lose interest.

Since the typing game apparatus according to the fifth aspect of the present invention has, as the image display for displaying the prescribed image related to the game, a first display screen and a second display screen disposed above the first display screen, compared to cases in which only one display screen is used, it is possible to provide a wide variety of typing games using images displayed respectively on the two display screens. Accordingly, a player playing the typing game does not lose interest, and enthusiasm for the game can be increased.

Furthermore, in the typing game apparatus according to the fifth aspect of the present invention, since the game information related to the progress of the game, including the prescribed character string, is displayed on the first display screen, and the presentation image, in which a game presentation is carried out, is displayed, in parallel with a display on the first display screen, on the second display screen, it is possible to display the effect presentation image that is not directly necessary for progressing with the game on a display screen separately from the game information that is necessary for progressing with the game. Accordingly, the player can easily perceive necessary information and can concentrate when playing the game. Furthermore, by displaying the effect presentation image using an independent display screen, typing games with a realistic feel not existing heretofore are possible and the player does not lose interest.

In addition, in the typing game apparatus according to the fifth aspect of the present invention, since an effect presentation image identical to the presentation image displayed on the second display screen is simultaneously displayed in the independent image area secured in the upper central region of the first display screen, and the presentation image is displayed on the first display screen, with easy perception of information necessary to the player ensured, the player's concentration on the game is not disturbed, and he or she can easily see the display contents of the second display screen on the first display screen.

Furthermore, in the typing game apparatus according to the sixth aspect of the present invention, since the voice is output with music at a specified tempo, based on the stored music data, the character string related to the output voice is displayed as the prescribed character string on the first display screen, and the presentation image related to the music is displayed on the second display screen, a typing game in which typing is carried out in accompaniment with the performed music is possible, and the presentation image related to the music, not directly necessary for progressing with the game, can be displayed on a display screen, separately from the character string related to the voice necessary for progressing with the game. Accordingly, the player can easily perceive necessary information and can concentrate when playing the game. Furthermore, by displaying the effect presentation image related to the music using an independent display screen, typing games with performance of music and also a realistic feel not existing heretofore are possible, and the player does not lose interest.

In the typing game apparatus according to the sixth aspect of the present invention, since an effect presentation image identical to the effect presentation image related to the music, displayed on the second display screen, is simultaneously displayed in the independent image area secured in the upper central region of the first display screen, and since easy perception of the character string related to the voice, that is information necessary to the player, is ensured, with the presentation image related to the music being displayed on the first display screen, the player's concentration on the game is not disturbed, and he or she can easily see the display contents (presentation image related to the music) of the second display screen on the first display screen.

Moreover, in the typing game apparatus according to the seventh aspect of the present invention, since a promotional video is used as the effect presentation image related to the music, a typing game with a realistic feel is possible, in which the form of a singing artist is displayed together with performance of the music, and the player does not lose interest.

### BRIEF DESCRIPTION OF THE DRAWINGS

FIG. 1 is a perspective view of a typing game machine related to Embodiment 1;

FIG. 2 is a schematic diagram showing display contents displayed on a first liquid crystal display device before starting a typing game;

FIG. 3A is a schematic diagram showing display contents displayed on a second liquid crystal display device during the typing game;

FIG. 3B is a schematic diagram showing display contents displayed on the first liquid crystal display device during the typing game;

FIG. 4A is a schematic diagram showing display contents displayed on the second liquid crystal display device during the typing game;

FIG. 4B is a schematic diagram showing display contents displayed on the first liquid crystal display device during the typing game;

FIG. 5 is a schematic diagram showing display contents displayed on the first liquid crystal display device after completion of the typing game;

FIG. 6 is a plan view showing a keyboard provided in the typing game machine related to Embodiment 1;

FIG. 7 is a schematic sectional view of any one of a plurality of keys provided in the keyboard;

FIG. 8 is a system block diagram showing a system including a typing game machine and a server related to Embodiment 1;

FIG. 9 is a block diagram schematically showing a control system for the typing game machine related to Embodiment 1;

FIG. 10 is a schematic diagram showing a music data storage area of a hard disk drive (HDD) of the typing game machine related to Embodiment 1;

FIG. 11 is a flowchart for a main program for a slot-machine related to Embodiment 1;

FIG. 12 is a flowchart for a music selection program for the slot-machine related to Embodiment 1;

FIG. 13 is a flowchart for a typing game execution program for the slot-machine related to Embodiment 1;

FIG. 14 is a perspective view of a typing game machine related to Embodiment 2;

FIG. 15 is a schematic diagram showing display contents displayed on a first liquid crystal display device before starting the typing game;

FIG. 16A is a schematic diagram showing display contents displayed on a second liquid crystal display device during the typing game;

FIG. 16B is a schematic diagram showing display contents displayed on the first liquid crystal display device during the typing game;

FIG. 17A is a schematic diagram showing display contents displayed on the second liquid crystal display device during the typing game;

FIG. 17B is a schematic diagram showing display contents displayed on the first liquid crystal display device during the typing game;

FIG. 18 is a plan view showing a keyboard provided in the typing game machine related to Embodiment 2;

FIG. 19 is a schematic sectional view of one of the keys provided in the keyboard;

FIG. 20 is a block diagram schematically showing a control system for the typing game machine related to Embodiment 2;

FIG. 21 is a schematic diagram showing a music data storage area of a HDD of the typing game machine related to Embodiment 2;

FIG. 22 is a flow chart for a main program for the typing game machine related to Embodiment 2; and

FIG. 23 is a flow chart for a typing game execution program for the typing game machine related to Embodiment 2.

### DETAILED DESCRIPTION OF THE INVENTION

### EMBODIMENT 1

A typing game apparatus of the present invention is explained in detail below, based on a specific embodiment of a cabinet-type typing game machine 1 installed in game centers and the like, with reference to the Figures. Here, the typing game machine 1 related to the present invention is configured so that the game is played by reproducing music from a speaker, and also sequentially displaying lyrics on a display device in accompaniment with music that is being played, with the player sequentially typing the lyrics displayed, via a keyboard. Moreover, the implemented typing game is formed of a plurality of stages corresponding to the number of songs in the music that is reproduced, and is configured so that at the time when one stage is completed, if the number of typing mistakes by the player is within a prescribed number, the game proceeds to a stage corresponding to the music of the next song, and the typing game can be continued.

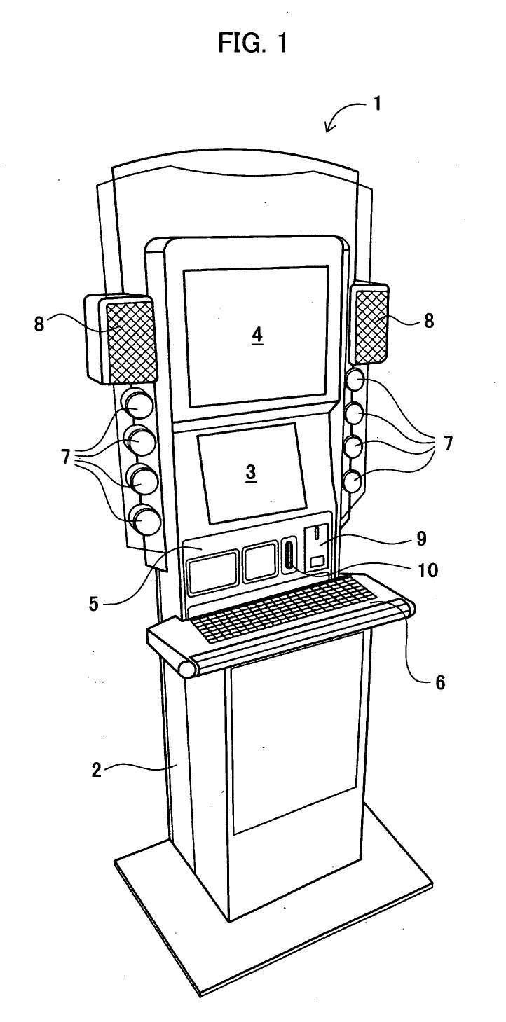

First, an outline configuration of the typing game machine 1 related to the present embodiment is explained referring to FIG. 1. FIG. 1 is a perspective view of a typing game machine related to the present embodiment.

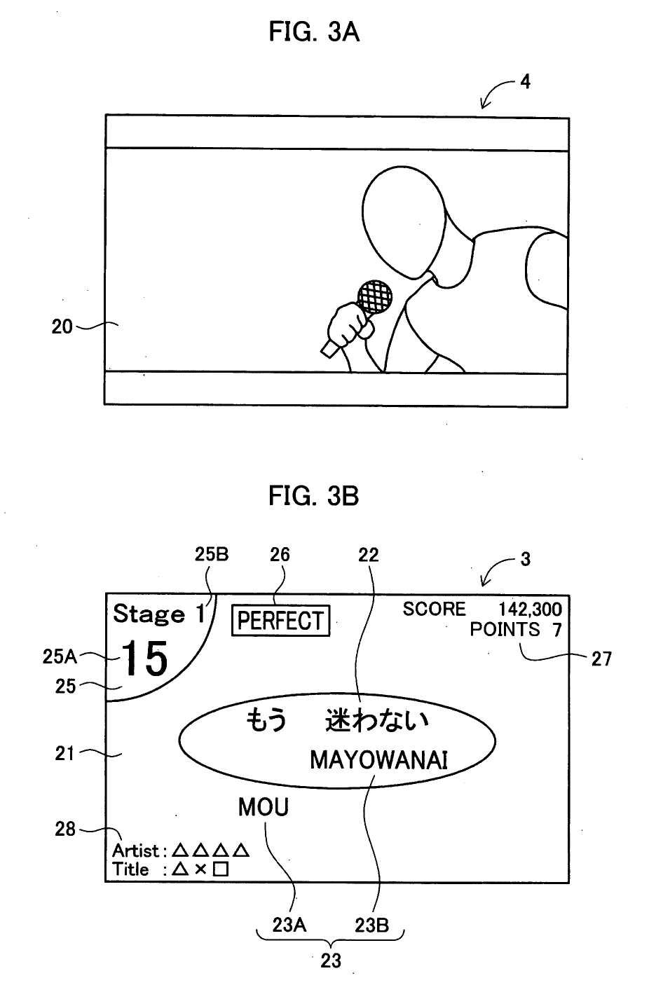

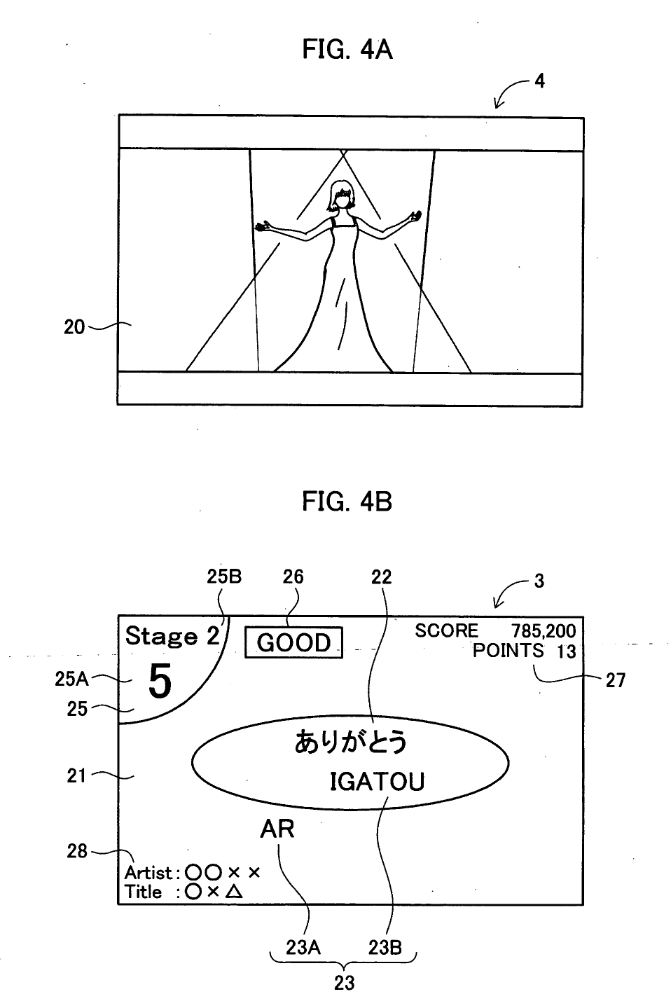

The typing game machine 1 of the present embodiment is basically formed, as shown in FIG. 1, of: a cabinet 2 forming the outer shape of the typing game machine 1, a first liquid crystal display device 3 for displaying a main game screen (see FIGS. 3B and 4B), a second liquid crystal display device 4, disposed above the first liquid crystal display device 3, for displaying an image (see FIGS. 3A and 4A) related to a presentation such as a promotional video, an advertisement, or the like, a center panel 5 arranged below the first liquid crystal display device 3, and in which insertion slots for a coin or a card are formed, a keyboard 6 on which a player types, external illumination LEDs 7 arranged on the left and right of the first liquid crystal display device 3, and a pair of speakers 8 located on the left and right sides of the second liquid crystal display device 4. Below, each constituent element is explained.

The first liquid crystal display device 3 is a liquid crystal display device disposed at a prescribed angular inclination at an approximately central region of the front face of the cabinet 2, and is disposed inclined at a prescribed angle to the rear. On the first liquid crystal display device 3, game information (necessary information for the player to progress with the game) related to progress of this typing game, such as the lyrics of the music reproduced via the speakers 8 when a typing game is played, the typing results of the player, and the score thereof, are displayed (see FIGS. 3B and 4B).

In addition, the second liquid crystal display device 4 separately disposed above the first liquid crystal display device 3 is a liquid crystal display device similar to the first liquid crystal display device 3, but the second liquid crystal display device 4 displays a presentation image related to a typing game presentation when the typing game is played.

Here, the presentation image displayed on the second liquid crystal display device 4 differs from the display contents displayed on the first liquid crystal display device 3, and is not directly necessary for the player to progress with the game, and has an auxiliary role of making the typing game exciting. For example, in the typing game machine 1 related to the present embodiment, a certain singer's music is played as the music, the player inputs the lyrics of the music via the keyboard 6 to progress with the game, and a promotional video (abbreviated to PV, below) related to the music is displayed on the second liquid crystal display device 4 (see FIGS. 3A and 4A). Accordingly, the typing game can have a realistic feel, in which the form of a singing artist is displayed together with the performance of the music, and the player does not lose interest. Furthermore, display contents displayed on the first liquid crystal display device 3 and the second liquid crystal display device 4 are explained in detail below.

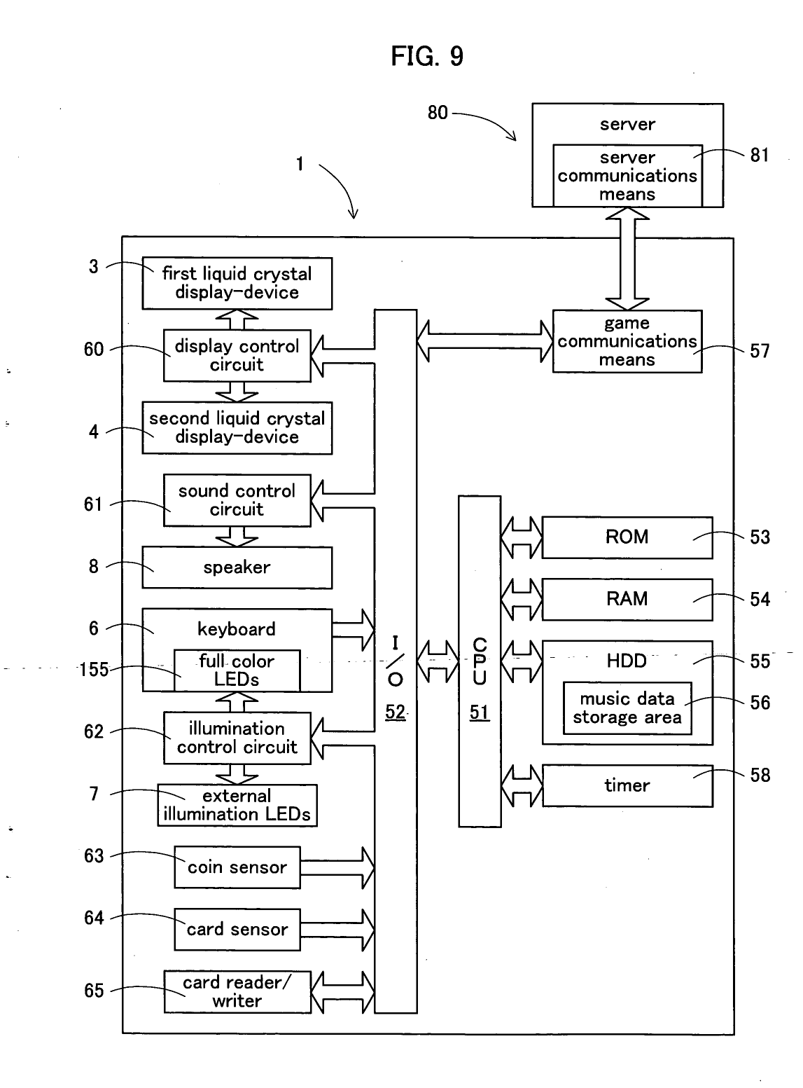

In addition, the coin insertion slot 9 and the card insertion slot 10 are provided on the center panel 5. The coin insertion slot 9 is a slot into which a hundred-yen coin or the like is inserted. A coin sensor 63 is disposed in the coin insertion slot 9, and when a coin is inserted in the coin insertion slot 9, a coin detection signal is output via the coin sensor 63 to a CPU 51 (see FIG. 9), and the CPU 51 detects that a coin has been inserted.

Furthermore, the card insertion slot 10 is an insertion slot into which is inserted an IC card (not shown in the Figure) with a built-in IC tag on which a game result of the typing game is recorded. Inside this card insertion slot 10, a card reader/writer 65 and card sensor 64, described below, are disposed (see FIG. 9), and in cases in which the IC card is inserted into the card insertion slot 10, this fact is detected by the card sensor 64. Here, the IC card, used in the typing game machine 1 of the present embodiment, stores game results (obtained score, points, and the like) for games up to the previous time for a player owning the card, on the built-in IC tag, and the game results stored thereon may be displayed to the player by performing a prescribed operation.

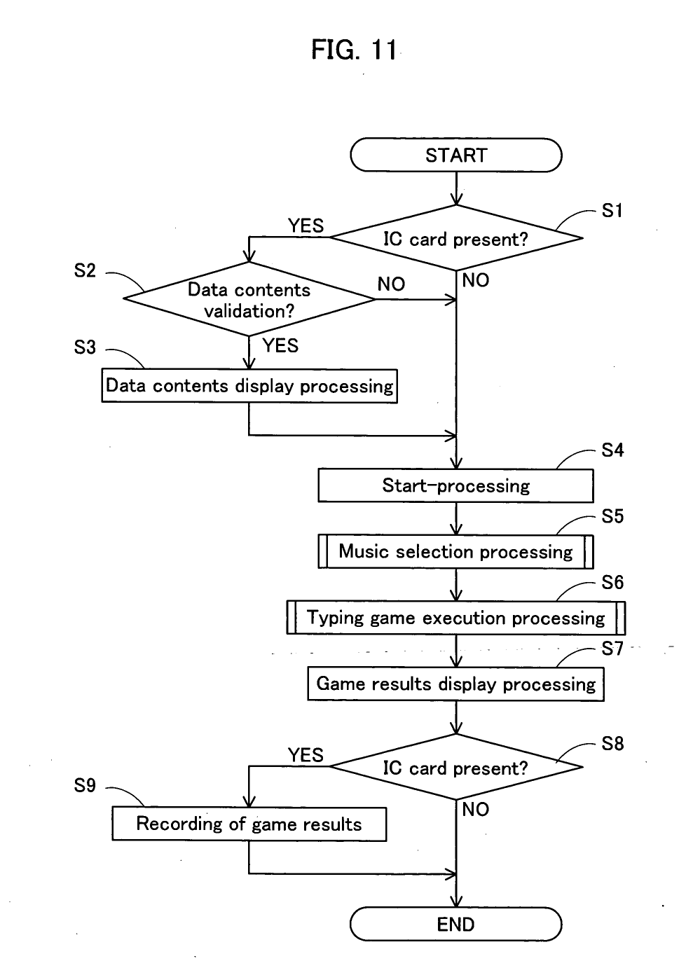

That is, in cases in which the IC card is detected by the card sensor 64, the card reader/writer 65 reads the game results of the typing game from the IC tag, or writes new game results to the IC tag (steps S3 and S9 in FIG. 11).

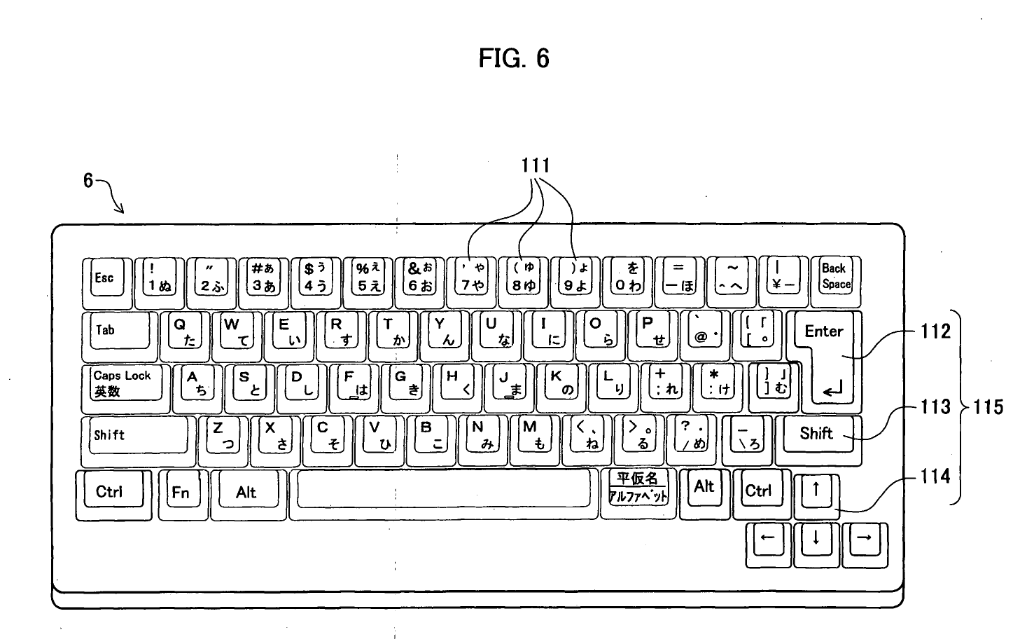

Furthermore, the keyboard 6 is disposed protruding outwards from the front face of the cabinet 2, and, as described below, is a Japanese 108-key keyboard on which a plurality of character input keys for performing input of Roman letters (A-Z), Japanese characters, numbers 0-9, symbols (period, comma), and the like, and function keys such as an enter key, cursor keys and the like, are respectively arrayed (see FIG. 6). In the game, the player performs character input by typing on various keys corresponding to characters, symbols, numbers, and the like, and progresses with the game, issuing commands by operation of various keys to select a tune for performing the game, and degree of game difficulty, before starting the game, after completing the game, or similar situations, and to start playing the game and the like. Furthermore, the configuration of the keyboard is explained in detail below.

Moreover, four external illumination LEDs 7 are disposed on each of both left and right sides of the cabinet 2. The external illumination LEDs 7 are formed of full color LEDs in which full color illumination is possible, and give varied lighting presentations in accordance with music being reproduced in the typing game machine 1. Lighting presentations may include, for example, a presentation in which lighting colors of all eight external illumination LEDs 7 are varied, a presentation in which lighting color variations are carried out in accordance with a defined rule, a presentation in which the external illumination LEDs 7 are illuminated and extinguished, and the like.

Furthermore, the speakers 8 are disposed on the two sides, left and right, of the second liquid crystal display device 4. The speakers 8 are output devices for outputting music, sound effects, and the like, reproduced in the typing game machine 1. Specifically, when the typing game is played, the music and voice are output at a prescribed tempo, based on the performance data and the voice data of the music stored in the HDD 55 (see FIG. 9).

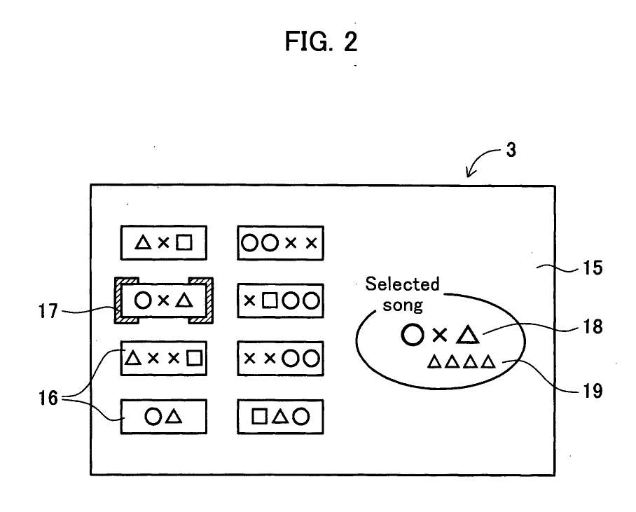

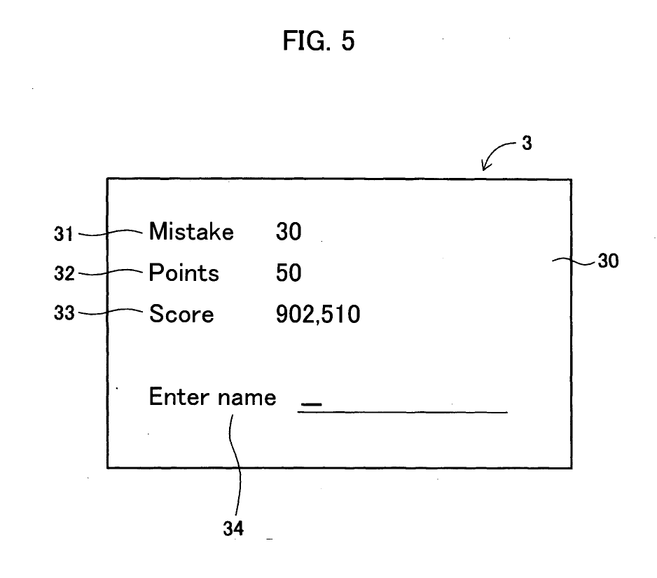

Next, each of the display contents displayed on the first liquid crystal display device 3 and the second liquid crystal display device 4 are explained in detail, using FIGS. 2 through 5. Moreover, the display contents displayed by the first liquid crystal display device 3 and the second liquid crystal display device 4 are basically configured from three patterns: before starting the typing game, during the typing game, and after finishing the typing game. FIG. 2 is a schematic diagram showing display contents displayed on the first liquid crystal display device 3 before starting the typing game, FIGS. 3A and 4A are schematic diagrams showing display contents displayed on the second liquid crystal display device 4 during the typing game, FIGS. 3B and 4B are schematic diagrams showing display contents displayed on the first liquid crystal display device 3 during the typing game, and FIG. 5 is a schematic diagram showing display contents displayed on the first liquid crystal display device 3 after finishing the typing game.

Here, in the typing game machine 1 of the present embodiment, the typing game is carried out by inputting the lyrics of the music being performed. Specifically, the player first selects desired music for the game from among a plurality of provided music. When the typing game is started, performance data for the music accompanying the selected pieces of music and voice data for the artist vocals of the pieces of music are reproduced. Furthermore, along with the reproduced performance data and voice data for the music, as a character string that the player must input, the music lyrics are displayed one phrase at a time in accompaniment with the reproduced voice data.

By inputting the character string corresponding to the displayed one-phrase lyrics, by the keyboard 6, the typing game progresses, and when the game is finished, the typing game results (number of typing mistakes, obtained score, points, and the like) are calculated based on various elements related to typing accuracy, timing of typing input, and the like, and are displayed. That is, the typing game in the typing game machine 1 is a competition regarding typing input skill levels, while enjoying the music performed during the game.

First, display contents before starting the typing game are explained using FIG. 2. As shown in FIG. 2, after a coin of a prescribed monetary value is inserted in the coin insertion slot 9, a tune selection screen 15 showing a list of possible music for the game in the typing game machine 1 is displayed on the first liquid crystal display device 3 before starting the typing game.

The tune selection screen 15 is composed of a playable song name display area 16 displaying song names of possible music for the game, a song selection cursor 17 that can select one name from the playable song name display area 16, a selected song name display area 18 in which the song name of music selected by the song selection cursor 17 is displayed, and a selected artist name display area 19 in which the artist name for the music selected by the selection cursor is displayed.

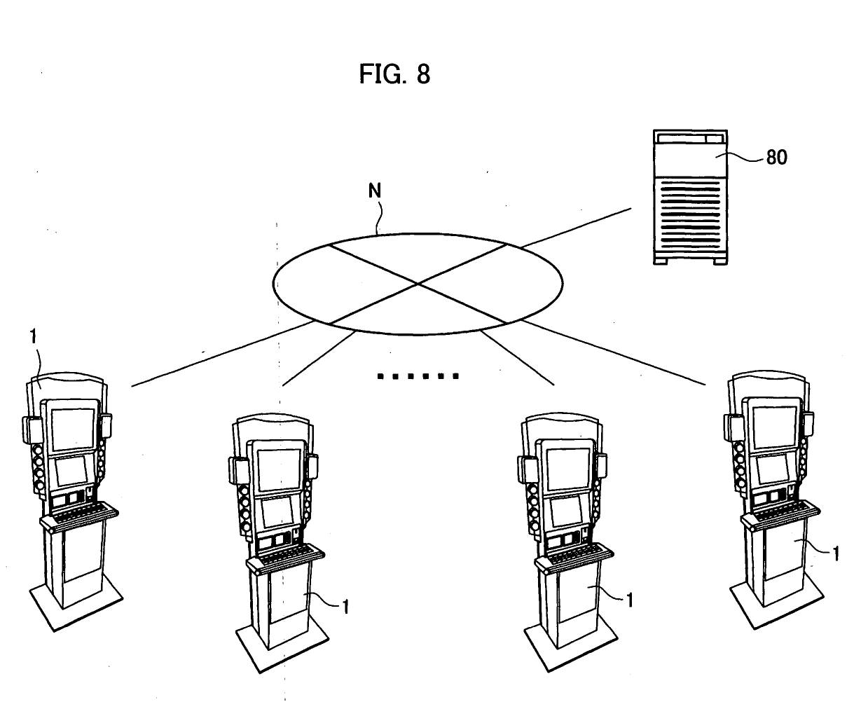

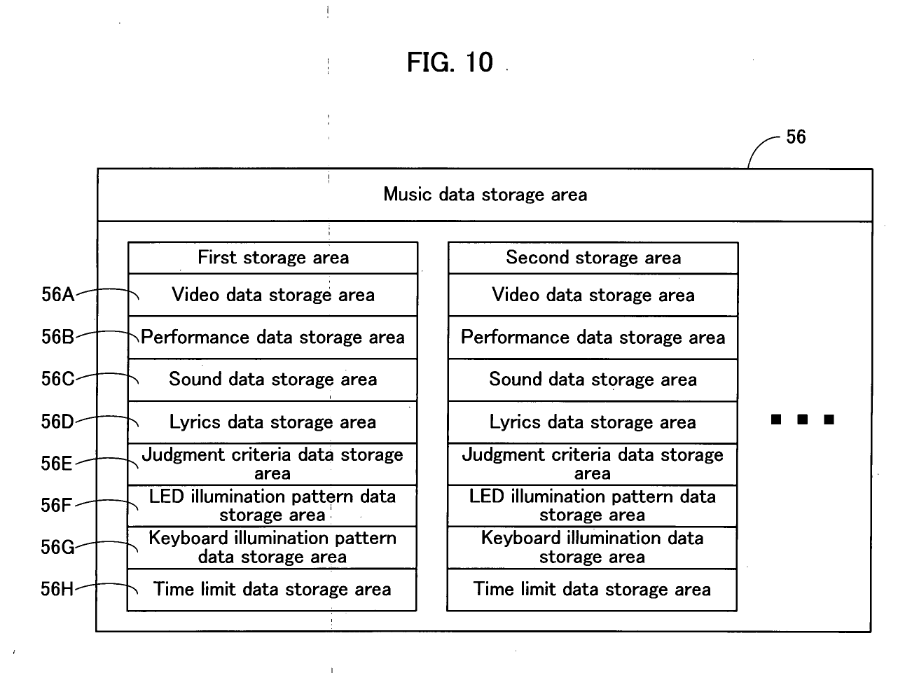

The playable song name display area 16 shows the respective song names of playable music (a maximum of eight songs in the present embodiment) in the current typing game machine 1. Here, playable music displayed in the playable song name display area 16 includes the music stored as music data in the HDD 55 described below (see FIGS. 9 and 10), and, furthermore, the stored music data is managed by a server 80 (see FIG. 8), and is sequentially updated. Accordingly, the player can select from among a plurality of pieces of music including the latest music updated by the server 80, and play the game. Furthermore, not only song names, but also artist photographs and PVs may be displayed in the playable song name display area 16.

Moreover, the song selection cursor 17 can be moved up, down, left, and right, over the playable song name display area 16 by operation of the cursor keys 114 (see FIG. 6) of the keyboard 6, and the song name and artist name for the music, on which the song selection cursor 17 is currently positioned in the playable song name display area the game-song name display area 16, are displayed in the selected song name display area 18 and the selected artist name display area 19.

When the enter key 112 (see FIG. 6) is pressed in a state in which the song selection cursor 17 is positioned over the playable song name display area 16 with the song name of desired music displayed, the music for playing the game is decided, and the typing game starts.

Moreover, while the song selection screen 15 is displayed on the first liquid crystal display device 3, optional PV music may be run on the second liquid crystal display device 4. Furthermore, an advertisement image or the like may also be displayed. In addition, the song selection screen 15 may be displayed, not on the first liquid crystal display device 3, but on the second liquid crystal display device 4.

Next, display contents during the execution of the typing game are explained using FIGS. 3 and 4. The display contents of the first liquid crystal display device 3 and the second liquid crystal display device 4 are shown, respectively, in FIGS. 3A and 3B for cases where a designated song A by a male artist is selected in the song selection screen 15 and the typing game is started, and in FIGS. 4A and 4B for cases where a designated song B by a female artist is selected in the song selection screen 15 and the typing game is started.

As shown in FIG. 3A, in cases where, for example, the song A is selected and a game is started, PV footage 20 of a male artist singing the song A, performed via the speakers 8, is displayed on the second liquid crystal display device 4. On the other hand, as shown in FIG. 4A, in cases where, for example, the song B is selected and a game is started, PV footage 20 of a female artist singing the song B, performed via the speakers 8, is displayed on the second liquid crystal display device 4.

In addition, as shown in FIGS. 3B and 4B, in parallel with the display of the PV footage 20 on the second liquid crystal display device 4, a main game screen 21 related to the progress of the typing game is displayed on the first liquid crystal display device 3.

Here, the main game screen 21 includes a lyrics display area 22 for displaying lyrics of a phrase currently being performed, using Chinese characters, Japanese characters, and the like, a Roman letters display area 23 for displaying the lyrics displayed in the lyrics display area 22 separately in Roman letters and also for showing an input result of the input the player types on the keyboard 6, a music state display area 25 for displaying the song number (stage number) and additionally the phrase number, counted from the start of this song number, for the phrase of the lyrics currently displayed in the lyrics display area 22 and in the Roman letters display area 23, a typing result display area 26 for displaying an error determination result for the player's typing, a score display area 27 for displaying a score, points, or the like, that the player has obtained up to now, and a song information display area 28 for displaying the artist's name and the song name currently being performed.

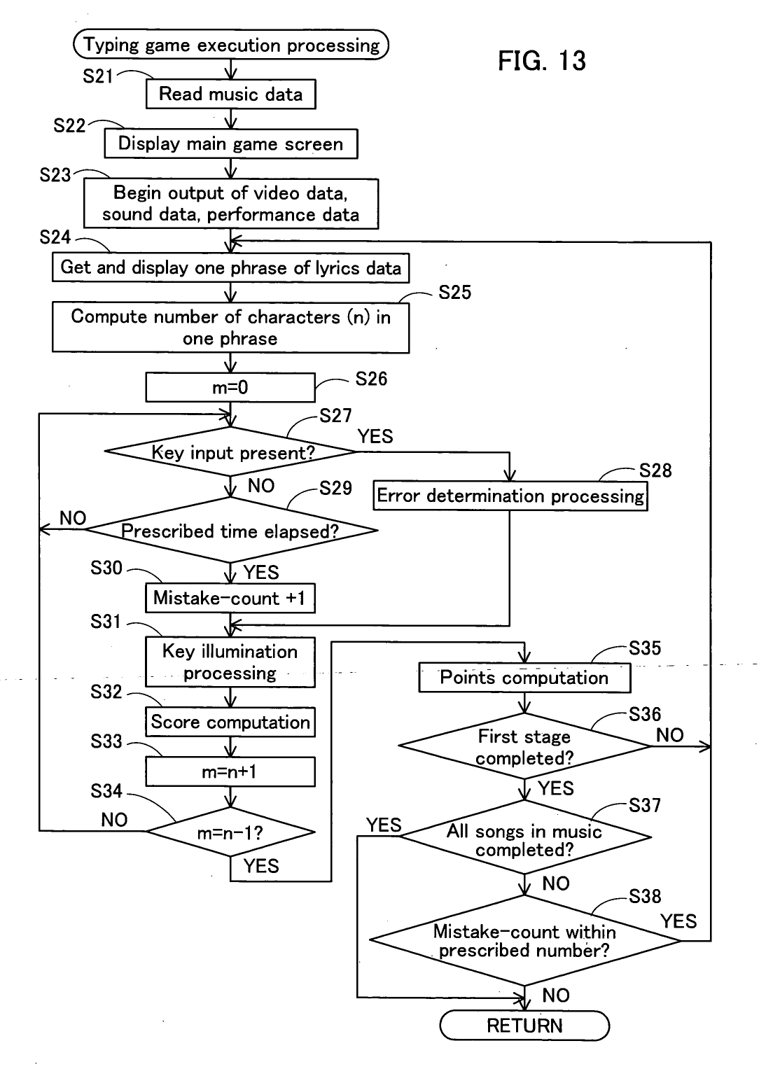

The lyrics display area 22 is a display area in which the lyrics of one phrase of the music currently being performed are displayed, and the game progresses by the player typing on the keyboard 6 the lyrics displayed in the lyrics display area 22. When the player correctly types the displayed lyrics, the score is gradually increased, and on the other hand, when mistakes are made in inputting the lyrics, the score is not increased, and additionally, a mistake count is incremented according to the number of input mistakes made. If, within a song number (stage) composed of the current music, this typing mistake count exceeds a prescribed number at the end of any song, the game is ended at that point (see step S38 in FIG. 13).

The lyrics of one phrase of the music currently being performed are displayed in the Roman letters display area 23 also, in the same way as in the lyrics display area 22, and the same lyrics are displayed in Roman letter notation. Moreover, in the displayed lyrics, the character string 23A already typed by the player is compared to the character string 23B before typing and is moved lower down and displayed, so that the player can be informed about the characters typed up to now.

In addition, the music state display area 25 indicates the song number of the lyrics phrase currently displayed in the lyrics display area 22 and the Roman letters display area 23, and displays the corresponding phrase number, counting from the start of the song. Here, the typing game related to the present embodiment is formed of a plurality of stages (for example, from a first to a third stage) corresponding to the song numbers (for example, from 1 to 3) of the reproduced music. For example, FIG. 3B shows the fifteenth phrase of the first stage (song number 1) currently being displayed. Additionally, FIG. 4B shows the fifth phrase of the second stage (song number 2) currently being displayed.

As each input of a single phrase by the player is completed, a numeric value 25A indicating the phrase number thereof is incremented by one, and as input of each single stage is completed, a numeric value 25B indicating the stage number (song number) thereof is incremented by one. In this way, the player can be informed of the current stage number (song number) and the number of phrases for which typing has been completed up to that time.

The typing result display area 26 is a display area for displaying an error determination result for the typing of the player, and in cases where correct characters corresponding to and with the same timing as the vocals of the performed music are typed, “PERFECT” is displayed. Furthermore, in cases where correct characters are typed with timing different from the vocals in the performed music, “GOOD” is displayed. However, irrespective of the timing, in cases in which mistaken characters are typed, “MISTAKE” is displayed.

The score display area 27 is a display area for displaying the score and points obtained by the player up to that time. Here, the score is incremented for correct typing in accordance with the character string displayed in the lyrics display area 22 and the Roman letters display area 23, and additionally, in cases where characters corresponding to, and with the same timing as, the voice in the performed music are typed, the score is further incremented. On the other hand, in cases where the text of one phrase is input without any typing mistake, the points are incremented by one (step S35 in FIG. 13).

Incrementing of the score and points is carried out until the game is completed, and in cases where the IC card is inserted in the card insertion slot 10 of the center panel 5, at the completion of the game the score and points obtained are stored on the IC card.

Furthermore, the song name and the artist name that the player selected at the start of the game and that are currently being performed are respectively displayed in the song information display area 28.

Furthermore, in the present embodiment, the main game screen 21 is displayed on the first liquid crystal display device 3, and the PV footage 20 is displayed on the second liquid crystal display device 4; however, conversely, the PV footage 20 may be displayed on the first liquid crystal display device 3, and the main game screen 21 may be displayed on the second liquid crystal display device 4.

As shown in FIG. 5, after the typing game has been completed, a game results screen 30 showing the game results for the typing game this time is displayed on the first liquid crystal display device 3.

The game results screen 30 is composed of a mistake count display area 31 displaying the number of typing mistakes for the typing game this time, an obtained points display area 32 for displaying the points obtained, an obtained score display area 33 for displaying the score obtained, and a name input display area 34 that prompts the player of the game to input his or her name.

By referring to the game results screen 30, the player can acknowledge the mistake count, and the obtained points and score, respectively, for the typing game this time. Furthermore, by inputting an optional name in the name input display area 34 using the keyboard 34, the obtained score can be recorded for ranking. A list of recorded rankings is displayed in a demonstration screen or the like, on the first liquid crystal display device 3 or the second liquid crystal display device 4.

Furthermore, while the game results screen 30 is displayed on the first liquid crystal display device 3, an optional music PV may be run on the second liquid crystal display device 4. Moreover, an advertisement video or the like may also be displayed. Additionally, the game results screen 30 may be displayed, not on the first liquid crystal display device 3, but on the second liquid crystal display device 4.

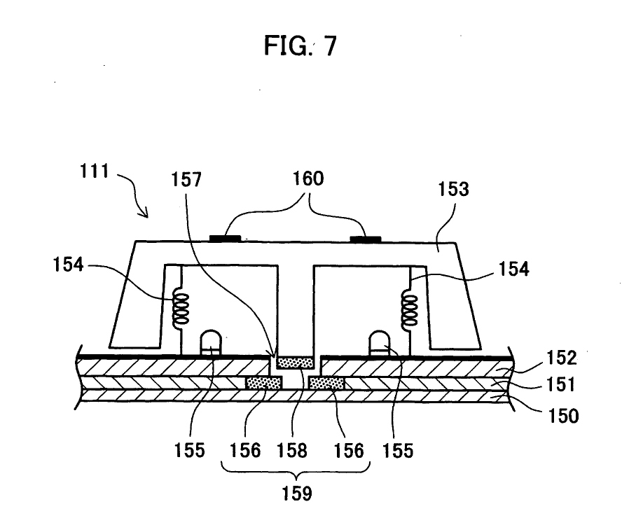

Next, the keyboard 6 provided in the typing game machine 1 is explained using FIGS. 6 and 7. FIG. 6 is a plan view showing the keyboard provided in the typing game machine related to the present embodiment. FIG. 7 is a schematic sectional view of any one of the plurality of keys provided in the keyboard.

As shown in FIG. 6, the keyboard 6 is a Japanese 108-key keyboard on which a plurality of character input keys 111 for performing input of Roman letters (A to Z), Japanese characters, numbers 0 to 9, symbols (period, comma), and the like, and function keys 115 such as an enter key 112, a shift key 113, cursor keys 114, and the like, are respectively arrayed. In the game, the player performs character input by typing on the character input keys 111 corresponding to characters, symbols, numerals, and the like, and progresses with the game, issuing commands by operation of the function keys 115, to select songs and degree of game difficulty for performing the game, before starting the game, after completing the game, or similar situations, and to start executing the game and the like. Furthermore, an illuminating LED is provided inside the various kinds of keys in the keyboard 6, and the keys are configured to emit light in various modes based on control signals from a CPU 51.

The internal structure of keys in the keyboard 6 is explained here, in accordance with FIG. 7. Furthermore, the plurality of keys arrayed in the keyboard 6 all have a similar internal structure. Accordingly, among the plurality of keys arrayed in the keyboard 6, the internal structure of one character input key 111 is explained below, as an example, and explanations of other character input keys 111 and the function keys 115 are omitted.

As shown in FIG. 7, the character input key 111 is basically composed of a base board 150, a switch circuit board 151, an illuminating circuit board 152, a key top 153, a biasing mechanism 154, and full color LEDs 155.

In this regard, a pair of electrodes 156, disposed directly beneath the vicinity of the center of the key top 153, are arranged in the switch circuit board 151 laid on the base board 150.

Furthermore, in order to expose the abovementioned pair of electrodes 156, an opening 157 is arranged in the illuminating circuit board 152 laid on the switch circuit board 151, and the full color LEDs 155 that can be illuminated in full color are arranged in the surrounding area of this opening 157.

Furthermore, the biasing mechanism 154 is arranged between the illuminating circuit board 152 and the key top 153, and the key top 153 is urged by this biasing mechanism 154 on the opposite side of the switch circuit board 151. In addition, in the vicinity of the center of the key top 153, an electrode 158 protrudes towards the switch circuit board 151. Accordingly, when a pressing operation is made on the key top 153, the electrode 158 protruding from the key top 153 can be made to touch the pair of electrodes 156 arranged on the switch circuit board 151, so that the fact that the key top 153 was pressed can be communicated as an electrical signal flowing in the switch circuit board 151. That is, a key switch 159 is configured from these three electrodes 156 and 158.

Furthermore, the biasing mechanism 154 may be composed of an elastic body only, of an elastic body and a bridge mechanism, or any suitable configuration.

Furthermore, the key top 153 is formed of a translucent material (for example, transparent acrylic, transparent plastic, or the like), with key information 160, such as characters, numerals, symbols, and the like, printed in black on the flat surface thereof. Additionally, the surface of the illuminating circuit board 152, on the key top 153 side, is also printed in black.

Therefore, when the full color LED 155 is extinguished, since the translucent key top 153 reflects the black color that is the color of the surface of the illuminating circuit board 152, the key information 160 printed in black on the key top 153, on which the black color is reflected, becomes hard to perceive.

However, when the full color LEDs 155 are illuminated, since the translucent key top 153 reflects the illuminated color of the full color LEDs 155, the key information 160 printed in black on the key top 153, on which the color is reflected, becomes easy to perceive.

In the keyboard 6, the key switch 159 in the internal part of each key is connected to a transmission circuit, which is not shown in the figures. The transmission circuit is connected to the CPU 51 of the typing game machine 1, via an interface unit 52 (referred to as I/O below), which is described below. Accordingly, by transmission of an electrical signal from the key switch 159 of a key that has been pressed, to the CPU 51, via the transmission circuit, it is possible to identify the type of key that has been pressed. Furthermore, the transmission circuit is installed on the abovementioned switch circuit board 151.

In addition, in the keyboard 6, the full color LEDs 155 inside the keys are connected to an illumination-control circuit 62. Furthermore, the illumination-control circuit 62 is connected via the I/O 52 to the CPU 51 (see FIG. 9). Accordingly, it is possible to illuminate the full color LEDs 155 inside the keys, via the illumination-control circuit 62, with a color specified by the CPU 51.

Specifically, in the typing game machine 1 related to the present embodiment, during a typing game, when there is key input and when it is judged that correct typing has been performed, the character input key 111 that was pressed is illuminated with a blue color. In addition, when there has been key input and it is judged that there has been a typing mistake, the character input key 111 that was pressed is illuminated with a red color, and the correct key that should have been used for input is illuminated with a green color. Furthermore, where there has been no key input, the correct key only, which should be used for input, is illuminated with a green color.

Moreover, as shown in FIG. 8, the typing game machine 1 related to the present embodiment is connected to a server 80 via a network N in which bi-directional communication is possible, such as the Internet or the like. Based on data transmitted from the server 80, it is possible to update the music data stored on the HDD 55 (see FIG. 9) of the typing game machine 1.

Accordingly, by updating the music data, it is possible to vary the types of playable music in the typing game machine 1, and by collectively managing the typing game machines installed in various game establishments, the task of updating the data is facilitated.

Next, a configuration related to a control system of the typing game machine 1 is explained, in accordance with FIG. 9. FIG. 9 is a block diagram schematically showing the control system of a typing game machine related to the present embodiment.

As shown in FIG. 9, the control system in the typing game machine 1 is configured from a CPU 51 for administering various types of control such as game processing operations and the like, in the typing game machine 1, a ROM 53 and a RAM 54 connected to the CPU 51, and peripheral devices (actuators) electrically connected to the CPU 51.

The CPU 51 is a central processing unit for performing computational processing according to various types of command. The I/O 52 is a connecting unit for electrically connecting, directly or indirectly, the first liquid crystal display device 3, the second liquid crystal display device 4, the keyboard 6, the external illumination LEDs 7, the speakers 8, and the like, to the CPU 51.

The ROM 53 is a nonvolatile read-only memory in which a program for running operations according to the flowchart described below is stored.

Moreover, the RAM 54 is a memory for temporarily storing various types of data computed by the CPU 51, and in the typing game, it stores the number of typing mistakes, the obtained score, the obtained points, and the like, for the player. In addition, in the plurality of music data stored on the HDD 55 described below, the lyrics data for the music data used in the current typing game is split into single phrases and temporarily stored in the RAM 54.

The HDD 55 is a storage device for storing the music data used when a typing game is executed on the typing game machine 1. Here, the music data is composed of video data, performance data, voice data, lyrics data, determination criteria data, LED illumination pattern data, keyboard illumination pattern data, and time-limit data, and each of these is stored in various storage areas of the music data storage area 56 formed on the HDD 55 (see FIG. 10). Furthermore, a plurality of music data items (in the present embodiment, a maximum of eight) are stored in the music data storage area 56, and the various music data items stored on the basis of data transmitted from the server 80, as described above, are continually updated. The varieties of song names displayed on the song selection screen 15 (see FIG. 2), based on the music data varieties stored in the music data storage area 56, are modified, and the typing game is played based on the music data corresponding to the music selected on the song selection screen 15 (see FIGS. 3 and 4).

Here, the music data storage area 56 formed on the HDD 55 is explained in detail, using FIG. 10. FIG. 10 is an explanatory diagram schematically showing the music data storage areas.

As shown in FIG. 10, the music data storage area 56 in the typing game machine 1 related to the present embodiment is composed of a plurality of storage areas (in the present embodiment, storage areas 1 to 8) corresponding to the number of pieces of music data that can be stored (eight songs in the present embodiment), and in each storage area, a video data storage area 56 A, a performance data storage area 56B, a voice data storage area 56C, a lyrics data storage area 56D, a determination criteria data storage area 56E, a LED illumination pattern data storage area 56F, a keyboard illumination pattern data storage area 56G, and a time limit data storage area 56H are arranged.

Each storage area is explained below. The video data storage area 56 A is a storage area for storing, among the music data, video data related to the PV footage 20 (see FIGS. 3A and 4A) of the artist displayed on the second liquid crystal display device 4.

The performance data storage area 56B is a storage area for storing, among the music data, performance data related to backing by musical instruments and the like, output from the speakers 8.

The voice data storage area 56C is a storage area for storing, among the music data, voice data related to vocals sung by the artist output from the speakers 8.

The lyrics data storage area 56D is a storage area for storing, among the music data, lyrics data related to text data for the music lyrics. As described above, when a typing game is played, the lyrics are displayed one phrase at a time on the first liquid crystal display device 3 (see FIGS. 3B and 4B).

The determination criteria data storage area 56E is a storage area for storing, among the music data, determination criteria data related to criteria for error determination of characters typed by the player and error determination of input timing, when a typing game is played. The CPU 51 increments the mistake count, the score, the points, and the like, as described below, based on the stored determination criteria data and operation signals from the keyboard 6.

Furthermore, the LED illumination pattern data storage area 56F and the keyboard illumination pattern data storage area 56G are storage areas for storing, among the music data, LED illumination pattern data for illuminating the external illumination LEDs 7, and keyboard illumination pattern data for illuminating the full color LEDs 155 arranged inside the keys. In the typing game machine 1 related to the present embodiment, the eight external illumination LEDs 7 are illumination-controlled to give respective illumination modes (illumination color, and whether illuminated or extinguished) by the illumination-control circuit 62 described below, when a typing game is being played, based on the stored LED illumination pattern data. Furthermore, the full color LEDs 155 arranged inside the keys are illumination-controlled to give respective illumination modes (illumination color, and whether illuminated or extinguished) by the illumination-control circuit 62 described below, when a typing game is being played, based on the stored keyboard illumination pattern data. In addition, illumination patterns for the full color LEDs 155 include, for a typing game novice, an illumination pattern for aiding key input by sequentially illuminating the keys that should be used for input with a different illumination color to the illumination color of the overall keyboard 6, and a pattern that varies the illumination color of all keys arrayed on the keyboard 6 in accompaniment with the music image.

The time limit data storage area 56H is a storage area for storing, among the music data, time limit data related to time limitations for usage of the music data, and the time limit data is composed of data concerning two dates: a date on which the music data can be used (usage commencement date) and a date on which the music data can no longer be used (usage termination date). This time limit data is used in a timer 58 (see FIG. 9) and also in management of usage time limitations for the various music data, and the CPU 51 provides control so that typing games using music data whose usage time limit has passed cannot be played.

Returning to FIG. 9, explanations of the control system of the typing game machine 1 are continued here.

A game communication device 57 is a device that converts signals sent out by the typing game machine 1 into signals in a transmittable format in accordance with communication formats for telephone lines, LAN cables, and the like, transmits them to the server 80, and receives signals transmitted from the server 80, reconverting them into signals in a format that the typing game machine 1 can read, and is connected to a server communication device 81 in the server 80 via a network N in which bi-directional communication is possible, such as the Internet or the like (see FIG. 8).

In addition, the timer 58 is connected to the CPU 51. Information from the timer 58 is transmitted to the CPU 51, and from the timer 58 information and the time limit data stored in the time limit data storage area 56 of the HDD 55, the CPU 51 manages the usage time limits for the stored music data.

Furthermore, the display control circuit 60 is connected, via the I/O 52, to the CPU 51, and is a unit for controlling display contents on the first liquid crystal display device 3 and the second liquid crystal display device 4, according to computational processing results of the CPU 51. Here, the display control circuit 60 is composed of a program ROM, an image ROM, an image control CPU, a working RAM, a VDP (video display processor), a video RAM, and the like. An image control program and various types of selection table related to the displays on the first liquid crystal display device 3 and the second liquid crystal display device 4 are stored in the program ROM. Additionally, in the image ROM, for example, dot data for forming images such as the song selection screen 15 (see FIG. 2), the main game screen 21 (see FIGS. 3 and 4), and the like, displayed on the first liquid crystal display device 3, is stored.

The image control CPU performs decision-making concerning images, from among the dot data stored in advance in the image ROM, displayed on the first liquid crystal display device 3 and the second liquid crystal display device 4, according to an image control program stored in advance in the program ROM, based on parameters set in the CPU 51. Furthermore, the VDP forms images according to display contents determined by the image control CPU, and outputs these to the first liquid crystal display device 3 and the second liquid crystal display device 4.

In this way, for example, in standby states, demonstration screens formed of optional music PVs, advertisements, ranking lists, and the like, are displayed, and after a coin has been inserted in the coin insertion slot 9, the song selection screen 15 (see FIG. 2) is displayed on the first liquid crystal display device 3. When a typing game is begun on the typing game machine 1, the lyrics data included in the music data is displayed one phrase at a time on the first liquid crystal display device 3, and based on an input result from the keyboard 6, control is performed to compare the character string 23A that the player has already typed, with a character string 23B before typing, and move it lower down. Meanwhile, the PV, that is video data included in the music data, is displayed on the second liquid crystal display device 4.

A sound control circuit 61 is connected to the CPU 51 via the I/O 52, and is also connected to the speakers 8. When the typing game is executed, and the music data stored in the music data storage area 56 of the HDD 55 is read, the performance data and the voice data included in the music data are converted into sound signals by the sound control circuit 61, and outputted by the speakers 8.

The illumination-control circuit 62 is connected to the CPU 51 via the I/O 52, and is also connected to the external illumination LEDs 7 and to the full color LEDs 155 (see FIG. 7) disposed inside the keys. When the music data stored in the music data storage area 56 of the HDD 55 is read by the CPU 51, the illumination-control circuit 62 controls the illumination mode of the external illumination LEDs 7 and the full color LEDs 155, based on the LED illumination pattern data and keyboard illumination pattern data included in the music data.

Furthermore, the keyboard 6 is connected to the CPU 51. The key switch 159 arranged inside each key of the keyboard 6 transmits the fact that the key top 153 has been pressed, as an electrical signal flowing in the switch circuit board 151. The CPU 51 performs control to execute various types of operation corresponding to the various keys, based on switch signals outputted from the various key switches 159, by pressing the various keys.

The coin sensor 63 is a sensor for detecting coins (for example, a one-hundred yen coin) used as value for executing typing games in the typing game machine 1. The coin sensor 63 is disposed inside the coin insertion slot 9, and is connected to the CPU 51 via the I/O 52. Therefore, on the basis of a coin inserted in the coin insertion slot 9, the coin sensor 63 transmits a coin insertion signal to the CPU 51. On detecting a coin insertion signal corresponding to a prescribed amount of money (for example, 200 yen), the CPU 51 enables execution of the typing game.

Furthermore, the card sensor 64 is a sensor for detecting whether or not an IC card is inserted in the card insertion slot 10, and the card reader/writer 65 is a device for performing reading and writing of data with respect to the IC tag disposed in the IC card. The card sensor 64 and the card reader/writer 65 are both disposed inside the card insertion slot 10, and are connected to the CPU 51 via the I/O 52. In cases where an IC card is detected by the card sensor 64 and a prescribed operation is performed, a game result of the typing game is read from the IC tag by the card reader/writer 65 (step S3 in FIG. 11). In addition, when a typing game is completed, writing of new game results (obtained score and points) to the IC tag is carried out (step S9 in FIG. 11).

Next, a main program which is run in the typing game machine 1 having the abovementioned configuration is explained, in accordance with FIG. 11. FIG. 11 is a flow chart for the main program of the typing game machine 1 related to the present embodiment. Furthermore, in the following, each program shown in the flowcharts in FIGS. 11 though 13 is stored in the ROM 53 and the RAM 54, provided in the typing game machine 1, and is executed by the CPU 51.

As shown in FIG. 11, firstly, based on a detection signal from the card sensor 64, the CPU 51 judges whether or not an IC card is inserted in the card insertion slot 10. In cases where it is judged that the IC card is inserted (step S1: YES), additionally, in step S2, a determination is made as to whether or not a request for validation of data contents has been received from the player. On the other hand, in cases where it is judged that an IC card is not inserted (step S1: NO), control moves to step S4.

Here, in the typing game machine 1 related to the present embodiment, in a state before a coin is inserted and when an IC card owned by the player has been inserted in the card insertion slot 10, when a shift key 113 on the keyboard 6 is pressed, a list of game results stored on the IC card (the score, the points, and the like, obtained by the player up to the previous game) is displayed on the first liquid crystal display device 3, and the player can confirm the contents thereof.

Accordingly, at step S2, a determination is made as to whether or not the shift key 113 has been pressed, based on an operation signal from the keyboard 6, and in cases where it is judged that the shift key 113 has been pressed (step S2: YES), data from the IC tag built into the IC card is read by the card reader/writer 65, and based on this read data, the list of game results is displayed on the first liquid crystal display device 3 (step S3).

Furthermore, in step S4 start-processing is performed. Specifically, in the start-processing, a determination is made as to whether or not a coin (a one-hundred yen coin or the like) of the prescribed monetary value (two hundred yen in the present embodiment) has been inserted in the coin insertion slot 9, and in a standby state while waiting for the insertion, a demonstration screen or the like, composed of a game screen with demonstration play, an optional music PV, an advertisement, a data ranking list, or the like, is displayed on a display device. Furthermore, in the typing game machine 1 related to the present embodiment, when a coin is inserted in the coin insertion slot 9, a detection is made by the coin sensor 63, and a coin detection signal is output to the CPU 51. In this way, the CPU 51 can judge whether the player has inserted the coin.

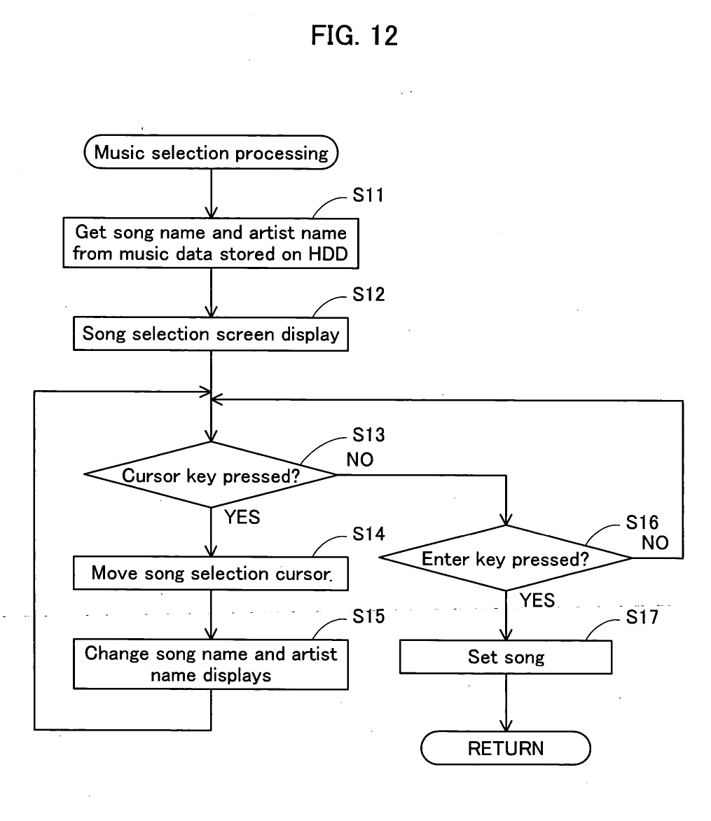

Next, in step S5, the music selection processing of FIG. 12 is performed. In the music selection processing, based on types of music data stored in the music data storage area 56 of the HDD 55, as described below, the song selection screen 15 (see FIG. 2) is displayed on the first liquid crystal display device 3, and the music to be used in this game is set.

In step S6, based on the music set in the abovementioned step S5, processing for executing a typing game as in FIG. 13 is performed. In the typing game execution, as described below, music is performed and the score, points, and the like are incremented based on a typing result of the keyboard 6, and this continues until the prescribed completion conditions are fulfilled.

After that, when the typing game execution has been completed, game results display processing is carried out (step S7). Specifically, in the game results display processing, based on the results of the typing game in the abovementioned step S6, the game results screen 30 (see FIG. 5) is displayed on the first liquid crystal display device 3. The number of typing mistakes, the obtained points, and the obtained score for this typing game, stored in the RAM 54, are respectively displayed in the game results screen 30, and in addition, a name input display area 34 prompting the player of the game to input his or her name is displayed. Furthermore, if keyboard 6 operations are carried out in this state, the characters input in the name input display area 34, based on operation signals, are displayed. In cases in which the obtained score equals or exceeds a prescribed score, ranking data stored in the RAM 54 is updated.

Next, in step S8, based on detection signals from the card sensor 64, the CPU 51 judges whether or not the IC card is inserted in the card insertion slot 10. In cases in which it is judged that the IC card is inserted (step S8: YES), additionally, in step S9, the points obtained and the score obtained in this typing game, stored in the RAM 54, are respectively written to the IC tag built into the IC card, by the card reader/writer 65. Furthermore, the written data here can be referred to in the data content display processing of the abovementioned step S3.

On the other hand, in cases in which it is judged that the IC card is not inserted (step S8: NO), this processing is ended.

Next, the music selection program of the abovementioned step S5 performed in the typing game machine 1 is explained, in accordance with FIG. 12. FIG. 12 is a flowchart for the music selection processing program related to the present embodiment.

In the music selection processing, first, in step S11, music song names and artist names (in the present embodiment, a maximum of eight varieties) related to the stored music data are respectively obtained from the music data storage area 56 of the HDD 55.

Based on the music song names and artist names obtained in the abovementioned step S11, the song selection screen 15 (see FIG. 2) is displayed on the first liquid crystal display device 3 (step S12). In the song selection screen 15, a list of music names obtained is displayed in the playable song name display area 16, and in addition, the music song name and artist name selected by the song selection cursor 17 are respectively displayed in the selected song name display area 18 and the selected artist name display area 19.

Next, in step S13, a determination is made as to whether or not a cursor key 114 has been pressed. Here, the determination as to whether or not the cursor key 114 has been pressed is based on an operation signal transmitted from the keyboard 6, and in cases in which it is judged that the cursor key 114 has been pressed (step S13: YES), based on the cursor key 114 operation (whether the upper, lower, left, or right key has been pressed), the song selection cursor 17 displayed on the first liquid crystal display device 3 is moved in the direction of the pressed key (step S14).

Additionally, in step S15, the selected song name display area 18 and the selected artist name display area 19 displays are respectively changed to the song name and artist name corresponding to the music newly selected by the song selection cursor 17 moved in the abovementioned step S14. After that, control returns to the determination processing of step S13.

On the other hand, in cases in which it is judged that a cursor key 114 has not been pressed (step S13: NO), then a determination is made in step S16 as to whether or not the enter key 112 has been pressed. In cases in which it is judged that the enter key 112 has been pressed (step S16: YES), the music at which the song selection cursor 17 is presently positioned is set as the music with which the typing game is performed this time (step S17), and the typing game described below is started. On the other hand, in cases in which it is judged that the enter key 112 has not been pressed (step S16: NO), control returns again to the determination processing of step S13.

Next, the typing game execution program of the abovementioned step S6 performed in the typing game machine 1 is explained, in accordance with FIG. 13. FIG. 13 is a flowchart for the typing game execution program of the present embodiment.

In the typing game execution processing, the CPU 51 first reads, from among the music data stored in the various storage areas (see FIG. 10) of the music data storage area 56 of the HDD in step S21, the music data corresponding to the music selected in the music selection processing of the abovementioned step S5. In particular, the lyrics data stored in the lyrics data storage area 56D is split up, phrase by phrase, and temporarily stored in the RAM 54.

Next, in step S22, the main game screen (see FIGS. 3B and 4B) is displayed on the first liquid crystal display device 3. Furthermore, at this time, a character string is not displayed in the lyrics display area 22 or in the Roman letters display area 23, and the points and score displays in the score display area 27 are “0”.

Next, based on the video data stored in the video data storage area 56A in step S23, display of PV footage 20 related to the selected music is commenced on the second liquid crystal display device 4 (see FIGS. 3A and 4A). In addition, output of music backing based on performance data stored in the performance data storage area 56B, via the speakers 8, and output of voice based on voice data stored in the voice data storage area 56C, are each implemented. In this way, music is performed and, in accompaniment therewith, the PV footage 20 is reproduced.

Next, in step S24, one phrase of the lyrics data stored in the RAM 54 is taken, and the corresponding character string is displayed, in accordance with the tempo of the music being performed, in each of the lyrics display area 22 and the Roman letters display area 23 of the main game screen 21. In this way, display of the main game screen 21 is carried out on the first liquid crystal display device 3 in parallel with the music performance and the display of the PV footage 20 on the second liquid crystal display device 4 (see FIGS. 3B and 4B).

After that, based on the lyrics data in the obtained one phrase, the number of characters, n, in the one phrase is computed (step S25), and “0” is assigned to a given variable, m, stored in the RAM 54 (step S26). Here, the given variable, m, is a variable used in character-input determination for each character of which the one phrase is formed, and each time determination of input of one character is completed, it is incremented by 1 (step S33). Therefore, in each input-determination processing performed repeatedly in steps S27 to S34 below, when m=t (t greater than or equal to 0, and less than or equal to n−1), input determination is performed for characters from the start of the one phrase to the (t+1)th position.

In step S27, based on an operation signal from the keyboard 6, a determination is made as to whether or not there has been key input by a character input key 111. In cases in which it is judged that there has been key input (step S27: YES), based on the type of key that was pressed and the determination criteria data stored in the determination criteria data storage area 56E, error determination processing is performed for the key used for input (step S28). Specifically, in cases where the key corresponding to a Roman letter displayed in the Roman letters display area 23 (see FIGS. 3B and 4B) of the main game screen 21 is pressed, the typing is recognized as being correct. In cases in which a key that does not correspond is pressed, the mistake count is incremented by 1. After that, control moves to step S31.

On the other hand, in cases where it is judged that there has not been key input (step S27: NO), determination as to whether or not a prescribed time (when a character at the start of one phrase is input, measured from after the character string corresponding to the one phrase is displayed on the main game screen 21 (step S24), and when a character other than that is input, from after score computation is performed (step S32)) has passed is made, based on information from the timer 58 (step S29). In cases where it is judged that the prescribed time has not passed (step 29: NO), control returns to the determination processing of step S27.

In contrast to this, in cases in which it is judged that the prescribed time has passed (step S29: YES), the fact that key input by the player has not been performed causes the mistake count for the present game, stored in the RAM 54, to be incremented by 1 (step S30).

Next, in step S31, illumination processing of keys is performed using the full color LEDs 155 arranged inside the keys of the keyboard 6. Specifically, in the typing game machine 1 related to the present embodiment, in cases in which there has been key input (step S27: YES), and where it is judged that the typing is correct, the character key 111 that was pressed is illuminated with a blue color. Furthermore, in cases in which there has been key input (step S27: YES), and where it is judged that the typing was incorrect, the character key 111 that was pressed is illuminated with a red color, and the correct key that should be typed is illuminated with a green color. Additionally, in cases in which there has been no key input (step S27: NO), the correct key that should be typed is illuminated with a green color.

Furthermore, in step S32, the score computation is performed based on the error determination processing of the abovementioned step S28. In the score computation, in cases in which it is judged that the typing was correct according to a determination by the abovementioned error determination processing, the player's score in the current game, stored in the RAM 54, is incremented, and in cases in which the relevant character is typed with the same timing as the voice in the performed music, the score is further incremented.

After that, in step S33, the variable, m, stored in the RAM 54 is read, incremented by +1, and stored again. Next, in step S34, a determination is made as to whether or not the value of the variable, m, has reached n−1, that is, whether or not input-determination has been completed for all characters with respect to each character forming the one phrase.

In cases in which it is judged that the value of the variable, m, has not reached n−1 (step S34: NO), control returns again to step S27, and among each of the characters forming the one phrase, input determination is performed for the character positioned next in sequence.

In contrast, in cases in which it is judged that the value of the variable, m, has reached n−1 (step S34: YES), input of the characters of the one phrase is complete and points computation is performed in step S35. In the points computation, in cases in which it is judged that input of the n characters forming the one phrase has been completed without a typing mistake (including determination of typing mistakes due to the prescribed time elapsing (step S30)), the points are incremented by 1.

Furthermore, in step S36, a determination is made as to whether or not, among the plurality of song numbers (normally, a song is numbered 1 to 3) that form the music, determination has been complete for phrase input for the stage corresponding to one of the song numbers. In cases in which it is judged that input determination for all phrases in one stage has not been completed (step S36: NO), control returns to step S24, the next lyrics phrase is taken from the RAM 54, and a corresponding character string is displayed in each of the lyrics display area 22 and the Roman letters display area 23 on the main game screen 21.

In contrast to this, in cases in which it is judged that input determination for all phrases in one stage has been completed (step S36: YES), a determination is then made as to whether or not input determinations for phrases at all stages (all music songs) has been completed (step S37).

In cases in which it is judged that all stages have been completed (step S37: YES), irrespective of the points held by the player, this typing game execution is completed, and control moves to the game results display processing of step S7. In contrast, in cases in which it is judged that all stages have not been completed (step S37: NO), a determination is made as to whether or not the typing mistake count of the player up to now, computed in the abovementioned steps S28 and S30, is within a prescribed number (step S38). The typing game machine 1 of the present embodiment, is configured of a plurality of stages corresponding to the number of songs in the played music, and at the point in time when one stage is completed, in order to continue to the stage corresponding to the next song number, the typing mistake count from the start of the game must be within the prescribed number (for example, in order to continue to number 2 after playing the portion corresponding to number 1, the typing mistake count must be less than 20, and in order to continue to number 3 after playing the portion corresponding to number 2, it must be less than 35).

In cases in which it is judged that the typing mistake count of the player computed in the abovementioned steps S28 and S30 is within the prescribed number (step S38: YES), control returns to step S24, the lyrics corresponding to the first phrase of the next song number are taken from the RAM 54, and the corresponding character string is displayed in each of the lyrics display area 22 and the Roman letters display area 23 on the main game screen 21. Input determination processing is performed in the same way. In contrast, where it is judged that the typing mistake count of the player is above the prescribed number (step S38: NO), processing for this typing game is completed, and control moves to the game results display processing of step S7.

As explained above, the typing game machine 1 related to the present embodiment includes two liquid crystal display devices (the first liquid crystal display device 3 and the second liquid crystal display device 4) in the front of the cabinet 2, and when a coin or the like is inserted in the coin insertion slot 9 and the typing game execution (step S6) is carried out, the promotional video footage 20 related to the performed music is displayed on the second liquid crystal display device 4 disposed in the upper portion of the cabinet 2 (step S23), and in parallel with this, the main game screen 21, on which the character string corresponding to the lyrics of the music is displayed, is displayed on the first liquid crystal display device 3 disposed in the lower portion of the cabinet 2 (steps S22 and S24), so that compared to cases in which only one display device is used, a varied typing game using display contents displayed individually on the two screens can be provided. Accordingly, a player playing the typing game does not lose interest, and enthusiasm for the game can be increased.

Furthermore, since the display of the promotional video footage 20 that is not directly necessary for progressing with the typing game is not performed on the main game screen 21, the player can easily perceive necessary information, and can concentrate on the game.

Additionally, by implementing the display of the promotional video footage 20 using an independent liquid crystal display device, a typing game with a realistic feel, not existing heretofore, is possible, with the form of the singing artist displayed together with the music performance, and the player does not lose interest.

### EMBODIMENT 2

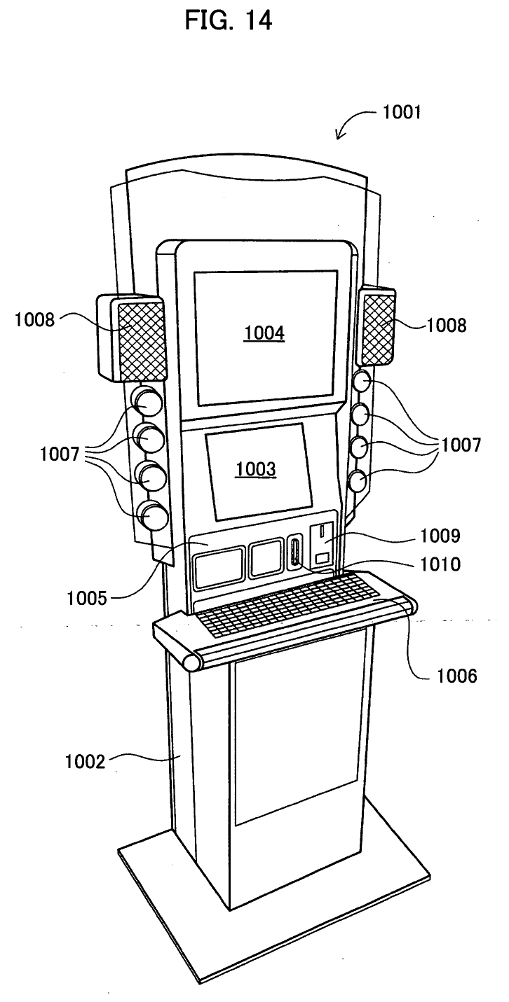

Embodiment 2 of the present invention is explained using FIGS. 14 through 23. Explanations of parts that are the same as in Embodiment 1 are omitted.

A first liquid crystal display device 1003 is a liquid crystal display device disposed at a prescribed angular inclination at approximately the central portion of the front face of the cabinet 1002, and is disposed with an inclination at a prescribed angle to the rear.

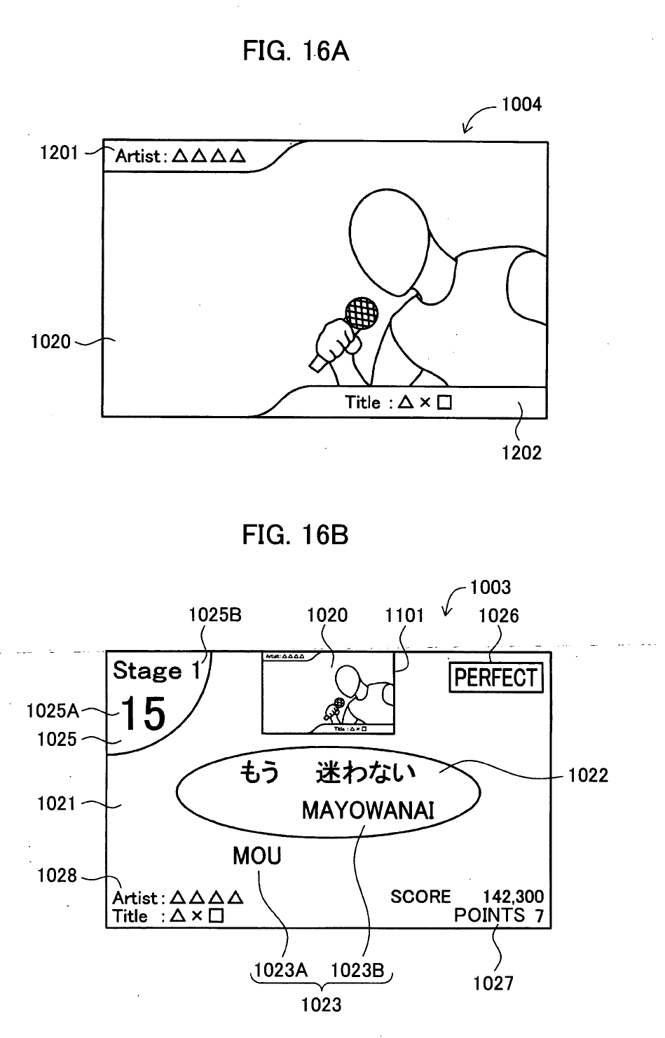

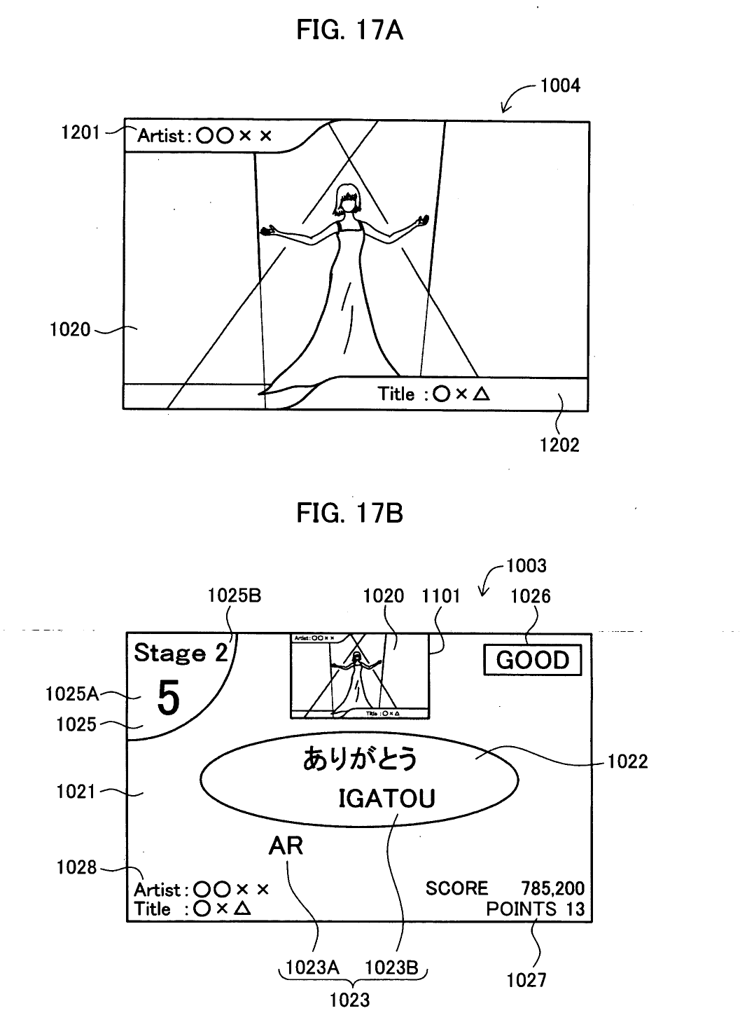

Music lyrics, reproduced via the speakers 1008 when a typing game is executed, typing results for a player, and game information (necessary information for the player in progressing with the game) related to progress of this typing game, such as the score thereof, and the like, are displayed on the first liquid crystal display device 1003 (FIGS. 16B and 17B).

In addition, a second liquid crystal display device 1004, separately disposed above the first liquid crystal display device 1003, is a liquid crystal display device similar to the first liquid crystal display device 1003, but the second liquid crystal display device 1004 displays a presentation image related to a typing game presentation, when the typing game is executed.

Here, the presentation image displayed on the second liquid crystal display device 1004 differs from the display contents displayed mainly on the abovementioned first liquid crystal display device 1003, and not being directly necessary for the player in progressing with the game, has an auxiliary role to make the typing game exciting. For example, in a typing game machine 1001 related to the present embodiment, a certain singer's music is reproduced as the music, the player inputs the music lyrics via a keyboard 1006 to progress with the game, and a promotional video (abbreviated to PV, below) related to the music is displayed on the second liquid crystal display device 1004 (see FIGS. 16A and 17A). Accordingly, the typing game can have a realistic feel, in which the form of a singing artist is displayed together with performance of the music, and the player does not lose interest. Furthermore, display contents displayed on the first liquid crystal display device 1003 and the second liquid crystal display device 1004 are explained in detail below.

In addition, four external illumination LEDs 1007 are disposed on each of both left and right sides of the cabinet 1002. The external illumination LEDs 1007 are formed of full color LEDs in which full color illumination is possible, producing varied lighting presentations in accordance with the music being reproduced in the typing game machine 1001. Lighting presentations may include, for example, a presentation in which lighting colors of all eight external illumination LEDs 1007 are varied, a presentation in which lighting color variations are carried out in accordance with a defined rule, a presentation in which the external illumination LEDs 1007 are illuminated and extinguished, and the like.

Here, the main game screen 1021 includes a lyrics display area 1022 for displaying lyrics of a phrase currently being performed, in Chinese characters, Japanese characters, or the like, a Roman letters display area 1023 for displaying the lyrics displayed in the lyrics display area 1022 separately as Roman letters and also for displaying an input result that a player inputs by typing on a keyboard 1006, a music state display area 1025 for displaying a song number (stage number) for the phrase of the lyrics currently displayed in the lyrics display area 1022 and the Roman letters display area 1023, and additionally the relevant phrase number counted from the start of the song, a typing result display area 1026 for displaying an error determination result for a player's typing, a score display area 1027 for displaying score, points, or the like, obtained up to now by the player, and a song information display area 1028 for displaying an artist name and a song name currently being performed, and the like.

Furthermore, as shown in FIGS. 16B and 17B, an independent image area 1101 is arranged in the upper central region of the main game screen 1021 on the first liquid crystal display device 1003. In this regard, the independent image area 1101 is arranged not to overlap with the lyrics display area 1022, the Roman letter display area 1023, the music state display area 1025, the typing results display area 1026, the score display area 1027, and the song information display area 1028, within the main game screen 1021. The PV footage 1020 displayed on the second liquid crystal display device 1004 is displayed with the same timing in the independent image area 1101.

Furthermore, as shown in FIGS. 16A and 17A, in the upper left corner area of the second liquid crystal display device 1004 in which the PV footage 1020 is displayed, an artist-name information display area 1201 displaying the name of the artist currently performing is arranged, and in the lower right corner area of the second liquid crystal display device 1004 in which the PV footage 1020 is displayed, a song-name information display area 1202 displaying the name of the song currently being performed is arranged. Moreover, as shown in FIGS. 16B and 17B, in the upper left corner area and the lower right corner area of the independent image area 1101 in the main game screen 1021 on the first liquid crystal display device 1003, the artist's name and the song name, respectively, are displayed.

In this regard, in the upper edge area and the lower edge area of the independent image area 1101, in addition to the artist's name and the song name, the phrase number for the music currently being performed, the stage number (song number) therefore, and the score, the points, and the like, obtained by the player up to now, may be displayed, or, conversely, may not be displayed.

Furthermore, in the present embodiment, the main game screen 1021 is displayed on the first liquid crystal display device 1003, and the PV footage 1020 is displayed on the second liquid crystal display device 1004; conversely, however, the PV footage 1020 may be displayed on the first liquid crystal display device 1003, and the main game screen 1021 may be displayed on the second liquid crystal display device 1004.

In this case, the independent image area 1101 is arranged in the upper central region of the main game screen 1021 displayed on the second liquid crystal display device 1004, and in this independent image area 1101 the PV footage 1020 displayed on the first liquid crystal display device 1003 is displayed with the same timing.

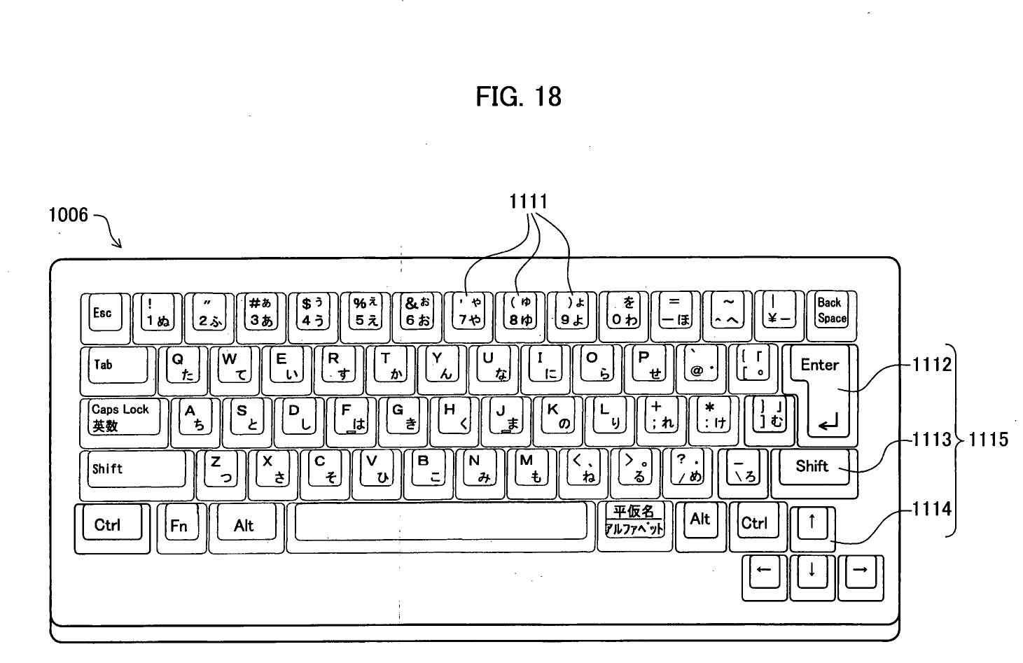

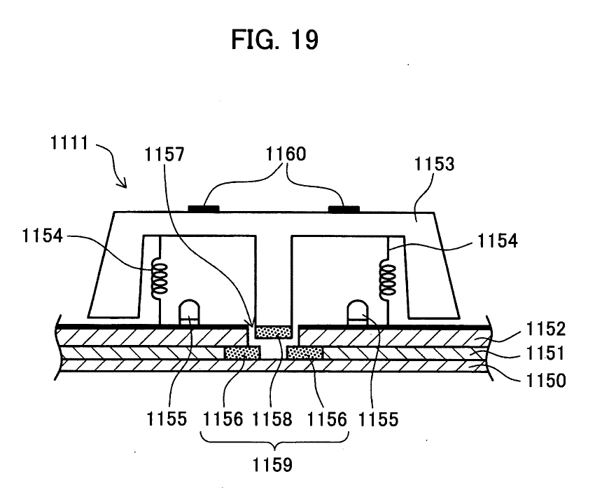

Using FIGS. 18 and 19, the keyboard 1006 in Embodiment 2 is explained. Explanations of parts that are the same as in the keyboard 6 of Embodiment 1 are omitted. In the keyboard 1006, a key switch 1159 inside each key is connected to a transmission circuit, which is not shown in the figures. The transmission circuit is connected to a CPU 1051 of the typing game machine 1001, via an interface unit 1052 (referred to as I/O below), which is described below. Accordingly, by transmission of an electrical signal from the key switch 1159 of a key that has been pressed, to the CPU 1051, via the transmission circuit, it is possible to identify the type of key that has been pressed. Furthermore, the transmission circuit is installed on the abovementioned switch circuit board 1151.

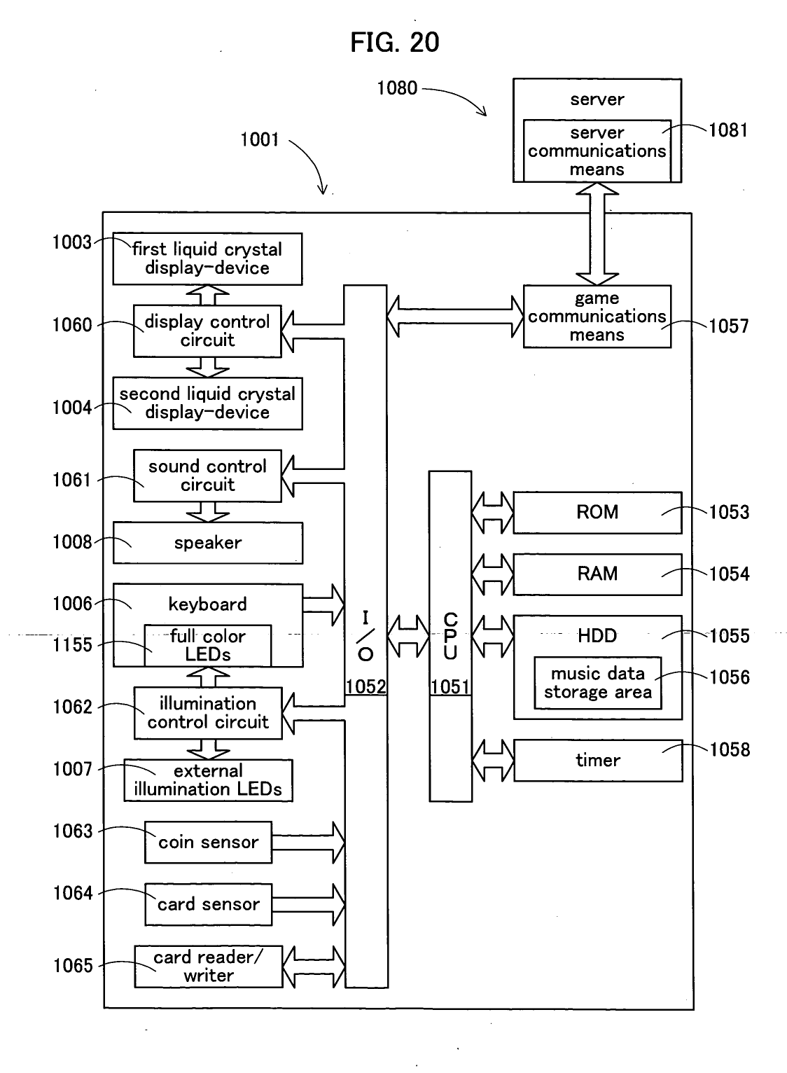

In addition, in the keyboard 1006, the full color LEDs 1155 that are inside the keys are connected to an illumination-control circuit 1062. Moreover, the illumination-control circuit 1062 is connected to the CPU 1051, via the I/O 1052 (see FIG. 20). Accordingly, via this illumination-control circuit 1062, the full color LEDs 1155 that are inside the keys can be illuminated with a color specified by the CPU 1051. Specifically, in the typing game machine 1001 related to the present embodiment, during a typing game, when there is key input, and when it is judged that correct typing has been performed, the character input key 1111 that was pressed is illuminated with a blue color. In addition, when there has been key input and it is judged that there has been a typing mistake, the character input key 1111 that was pressed is illuminated with a red color, and the correct key that should have been used for input is illuminated with a green color. Furthermore, where there has been no key input, the correct key only, which should be used for input, is illuminated with a green color.

A configuration for a control system for the typing game machine 1001 in Embodiment 2 is explained in accordance with FIG. 20. FIG. 20 is a block diagram schematically showing the control system for the typing game machine 1001 in Embodiment 2. Furthermore, explanations of parts that are the same as in Embodiment 1 are omitted.

The CPU 1051 is a central processing unit for performing processing according to various types of command. The I/O 1052 is a connecting unit for electrically connecting, directly or indirectly, the first liquid crystal display device 1003, the second liquid crystal display device 1004, the keyboard 1006, the external illumination LEDs 1007, the speakers 1008, and the like, to the CPU 1051.

The ROM 1053 is a nonvolatile read-only memory in which a program for running operations according to the flowchart described below is stored.

Furthermore, the RAM 1054 is a memory for temporarily storing various types of data computed in the CPU 1051, and the typing mistake count, score obtained, points obtained, and the like, for a player of this typing game are also stored. In addition, among the plurality of music data stored in a HDD 1055 described below, the lyrics data for the music data used in the current typing game are split into single phrases and are temporarily stored in the RAM 1054.

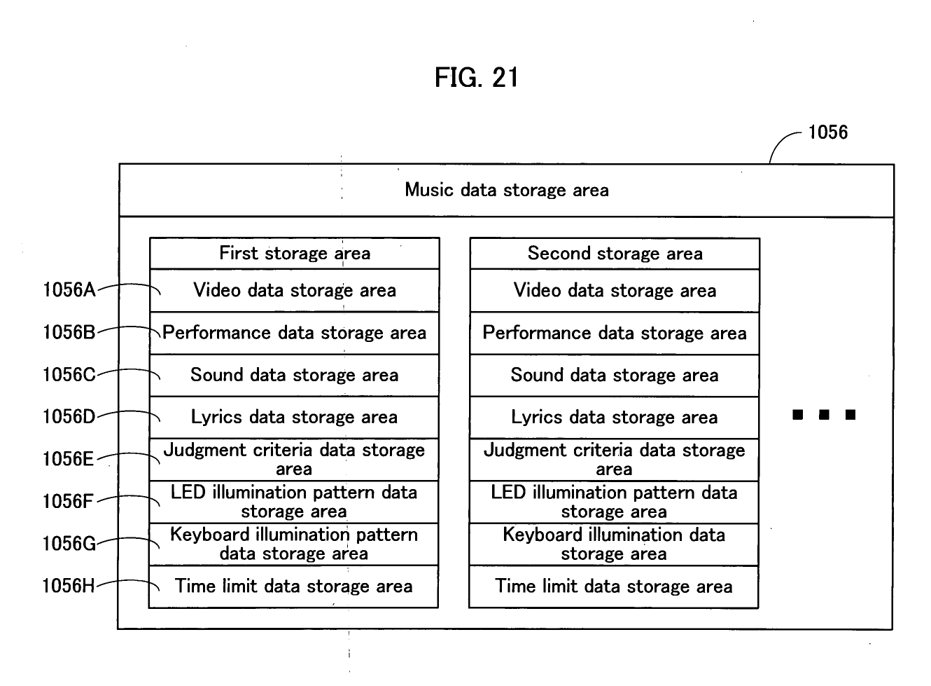

In addition, the music data storage area 1056 formed in the HDD 1055 in Embodiment 2 is explained in detail using FIG. 21. FIG. 21 is an explanatory diagram schematically showing the music data storage areas. Furthermore, parts that are the same as in Embodiment 1 are omitted.

Each storage area is explained below. The video data storage area 1056 A, is a storage area for storing, among the music data, video data related to the PV footage 1020 (see FIGS. 16A and 17A) of the artist displayed in the independent image area 1101 of the main game screen 1021 on the first liquid crystal display device 1003 and with the same timing on the second liquid crystal display device 1004.

Furthermore, the performance data storage area 1056B is a storage area for storing, among the music data, performance data related to backing by musical instruments and the like, outputted from the speakers 1008.

In addition, the voice data storage area 1056C is a storage area for storing, among the music data, voice data related to vocals sung by the artist outputted from the speakers 1008.

Furthermore, the lyrics data storage area 1056D is a storage area for storing, among the music data, lyrics data related to text data for the music lyrics. As described above, when a typing game is executed, the lyrics are displayed one phrase at a time on the first liquid crystal display device 1003 (see FIGS. 16B and 17B).

The determination criteria data storage area 1056E is a storage area for storing, among the music data, determination criteria data related to criteria for error determination of characters typed by the player and error determination of input timing, when a typing game is executed. The CPU 1051 increments the mistake count, score, points, and the like, based on the stored determination criteria data and operation signals from the keyboard 1006.

Furthermore, the LED illumination pattern data storage area 1056F and the keyboard illumination pattern data storage area 1056G are storage areas for storing, among the music data, LED illumination pattern data for illuminating the external illumination LEDs 1007, and keyboard illumination pattern data for illuminating the full color LEDs 1155 arranged inside the keys. In the typing game machine 1001 related to the present embodiment, the eight external illumination LEDs 1007 are illumination-controlled to produce several illumination modes (illumination color, and whether illuminated or extinguished) by an illumination-control circuit 1062 described below, when a typing game is being played, based on the stored LED illumination pattern data. Furthermore, the full color LEDs 1155 arranged inside the keys are illumination-controlled to produce several illumination modes (illumination color, and whether illuminated or extinguished) by the illumination-control circuit 1062 described below, when a typing game is executed, based on the stored keyboard illumination pattern data. In addition, illumination patterns for the full color LEDs 1155 include, for a typing game novice, an illumination pattern for aiding key input by sequentially illuminating the keys that should be used for input with a different illumination color to the illumination color of the overall keyboard 1006, and a pattern that varies the illumination color of all keys arrayed on the keyboard 6 in accompaniment with the music image.

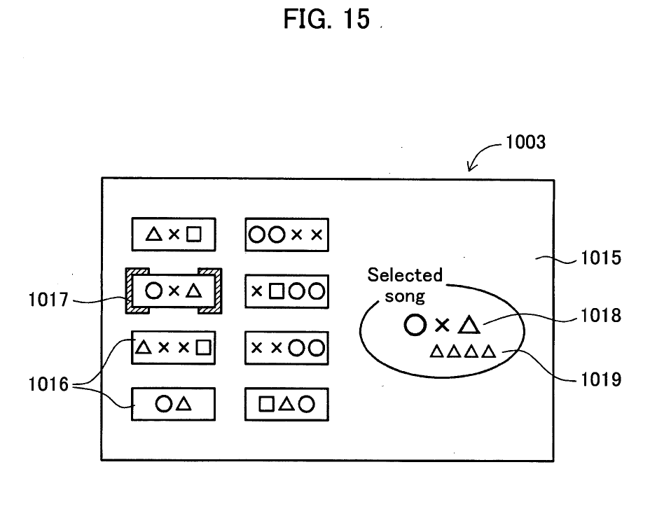

Furthermore, a display control circuit 1060 is connected to the CPU 1051 via the I/O 1052, and is a member for controlling display contents of the first liquid crystal display device 1003 and the second liquid crystal display device 1004, according to the computed results of the CPU 1051. Here, the display control circuit 1060 is composed of a program ROM, an image ROM, an image control CPU, a working RAM, a VDP (video display processor), a video RAM, and the like. An image control program and various types of selection table related to the displays on the first liquid crystal display device 1003 and the second liquid crystal display device 1004 are stored in the program ROM. In particular, the independent image area 1101 is arranged in the upper central region of the main game screen 1021 on the first liquid crystal display device 1003, and the image control program and the various types of selection table, which are necessary when the PV footage 1020 is displayed with the same timing in the independent image area 1101 and the second liquid crystal display device 1004, are stored. Additionally, in the image ROM, for example, dot data for forming images such as the song selection screen 1015 (see FIG. 15), the main game screen 1021 (see FIGS. 16 and 17), and the like, displayed on the first liquid crystal display device 1003, are stored.

The image control CPU performs decision-making concerning images, from among the dot data stored in advance in the image ROM, displayed on the first liquid crystal display device 1003 and the second liquid crystal display device 1004, according to the image control program stored in advance in the program ROM, based on parameters set in the CPU 1051. Furthermore, the VDP forms images according to display contents determined by the image control CPU, and outputs to the first liquid crystal display device 1003 and the second liquid crystal display device 1004.

In this way, for example, in standby states, demonstration screens formed of optional PV music, advertisements, ranking lists, and the like, are displayed, and after a coin has been inserted in a coin insertion slot 1009, the song selection screen 1015 (see FIG. 15) is displayed on the first liquid crystal display device 1003. When a typing game is begun on the typing game machine 1001, the lyrics data that is included in the music data is displayed one phrase at a time on the first liquid crystal display device 1003, and based on a result of input from the keyboard 1006, control is performed to compare a character string 1023A that the player has already typed, with a pre-typing character string 1023B, and move it lower down. Meanwhile, the PV, that is the video data included in the music data, is displayed on the second liquid crystal display device 1004. Furthermore, the independent image area 1101 is arranged in the upper central region of the main game screen 1021 on the first liquid crystal display device 1003, and the PV is displayed with the same timing in the independent image area 1101 and the second liquid crystal display device 1004.

The illumination-control circuit 1062 is connected to the CPU 1051, via the I/O 1052, and is connected to the external illumination LEDs 1007 and the full color LEDs 1155 (see FIG. 20) that are disposed inside the keys. When the music data stored in the music data storage area 1056 of the HDD 1055 is read by the CPU 1051, the illumination-control circuit 1062 performs control of illumination modes of the illumination lights 1007 and the full color LEDs 1155, based on the LED illumination pattern data and the keyboard illumination pattern data included in the music data.

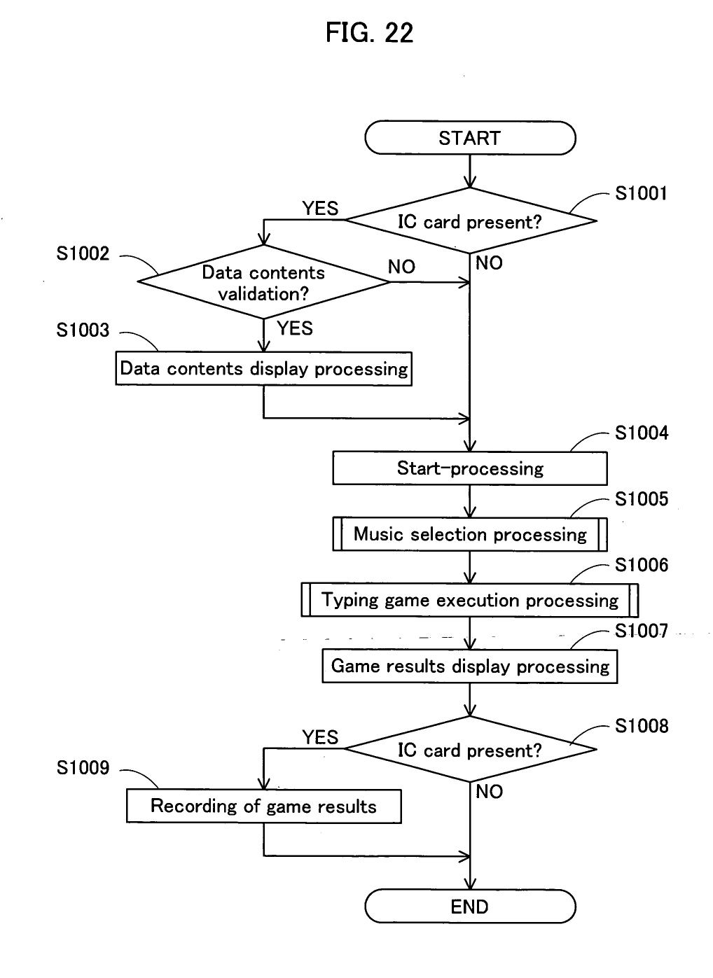

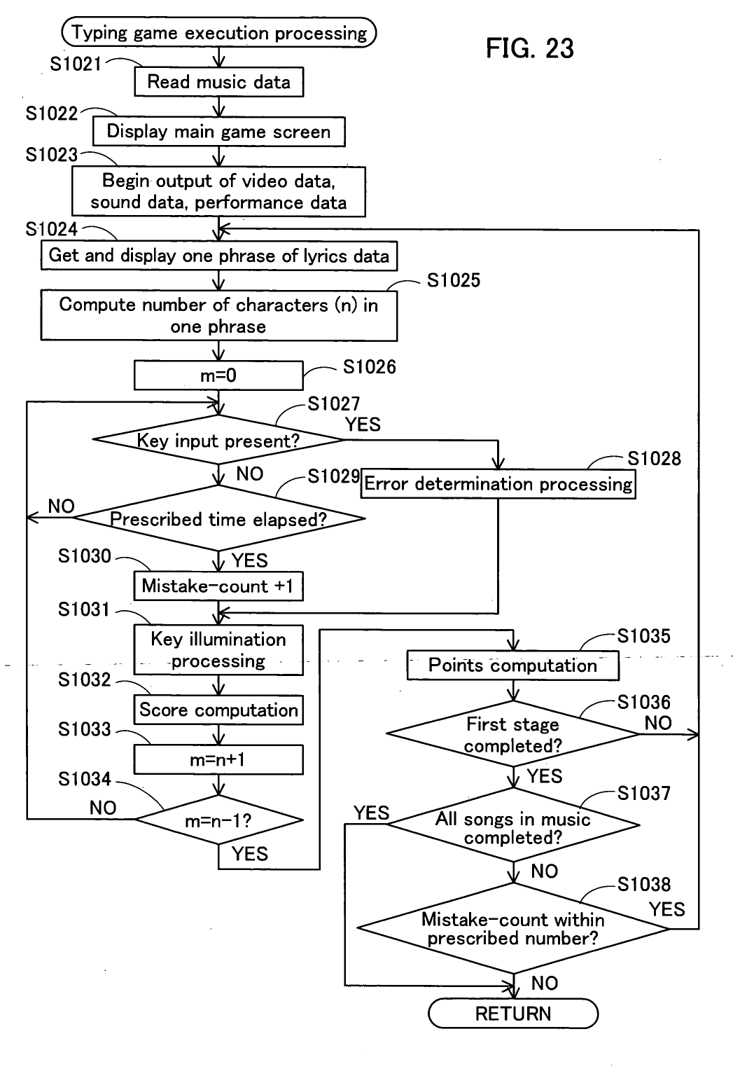

Next, a main program run in the typing game machine 1001 having the abovementioned configuration is explained, in accordance with FIG. 22. FIG. 22 is a flow chart for the main program of the typing game machine 1001 of the present embodiment. Furthermore, in the following, each program shown in the flow charts in FIGS. 22 and 23 is stored in the ROM 1053 and/or the RAM 1054, provided in the typing game machine 1001, and is executed by the CPU 1051. In addition, explanations of processing similar to that in Embodiment 1 are omitted for FIGS. 22 and 23.

As shown in FIG. 22, in the main processing, first, in step S1001, the CPU 1051 judges whether or not an IC card is inserted in the card insertion slot 1010, based on a detection signal from a card sensor 1064. In cases in which it is judged that the IC card is inserted (step S1001: YES), in step S1002, a determination is additionally made as to whether or not a request for validation of data contents has been received from the player. On the other hand, in cases in which it is judged that an IC card is not inserted (step S1001: NO), control moves to step S1004. Other processing in the main processing is the same as in Embodiment 1 and is omitted here.

Next, an execution program for the typing game performed in step S1006 (see FIG. 22) in the typing game machine 1001 is explained, in accordance with FIG. 23. FIG. 23 is a flow chart for the execution program for the typing game related to the present embodiment.

In the typing game execution in Embodiment 2, in step S1022, the main game screen 1021 (see FIGS. 16B and 17B) is displayed on the first liquid crystal display device 1003. At this time, the independent image area 1101 is arranged in the upper central region of the main game screen 1021 on the first liquid crystal display device 1003. Furthermore, at this time, a character string is not displayed in the lyrics display area 1022 or the Roman letters display area 1023 in the main game screen 1021, and the score and points display in the score display area 1027 are “0”. Furthermore, at this time, the PV footage 1020 is not displayed in the independent image area 1101.

Next, in step S1023, based on the video data stored in the video data storage area 1056A, display of the PV footage 1020 related to the selected music is begun with the same timing in the independent image area 1101 of the main game screen 1021 on the first liquid crystal display device 1003 and on the second liquid crystal display device 1004 (see FIGS. 16A and 17A). In addition, output of back-up music based on performance data stored in the performance data storage area 1056B, and output of voice based on voice data stored in the voice data storage area 1056C are each performed, via the speakers 1008. In this way, music is performed and, in accompaniment thereto, the PV footage 1020 is reproduced. Explanations concerning typing game execution processing that are the same as for Embodiment 1 are omitted.

As explained above, the typing game machine 1001 related to the present embodiment includes two liquid crystal display devices (the first liquid crystal display device 1003 and the second liquid crystal display device 1004) in the front of the cabinet 1002, and when a coin or the like is inserted in the coin insertion slot 1009 and the typing game execution processing (step S1006) is performed, the PV (promotional video) footage 1020 related to the performed music is displayed on the second liquid crystal display device 1004 disposed in the upper portion of the cabinet 1002 (step S1023), and in parallel with this, the main game screen 1021, on which the character string corresponding to the lyrics of the music is displayed, is displayed on the first liquid crystal display device 1003 disposed in the lower portion of the cabinet 1002 (steps S1022 and S1024), so that compared to cases in which only one display device is used, a varied typing game using display contents displayed individually on the two screens can be provided. Therefore, a player playing the typing game does not lose interest, and enthusiasm for the game can be increased.

Furthermore, since the display of the promotional video footage 1020, that is not directly necessary for progressing with the typing game, is not done on the main game screen 1021, the player can easily perceive necessary information, and can concentrate on the game.

In addition, by the display of the PV (promotional video) footage 1020 being performed using the second liquid crystal display device 1004 that is independent of the first liquid crystal display device 1003, a typing game with a realistic feel, not existing heretofore, in which the form of the singing artist is displayed together with the music performance, is possible and the player does not lose interest.

In addition, in the typing game machine 1001 of the present embodiment, since a video identical to the PV (promotional video) footage 1020, displayed on the second liquid crystal display device 1004, is displayed with the same timing in the independent image area 1101 arranged in the upper central region of the main game screen 1021 on the first liquid crystal display device 1003 (steps S1022 and S1023), and since the PV (promotional video) footage 1020 is displayed on the first liquid crystal display device 1003 while ensuring easy perception of information necessary to the player that is displayed in the lyrics display area 1022, the Roman letters display area 1023, and the like, the player can easily see the PV (promotional video) footage 1020 displayed on the second liquid crystal display device 1004, in the independent image area 1101 of the main game screen 1021 on the first liquid crystal display device 1003, without concentration on the game being disturbed.

In this regard, the independent image area 1101 of the main game screen 1021 on the first liquid crystal display device 1003 is arranged in the upper central region of the main game screen 1021, and since it is arranged inside the main game screen 1021 on the first liquid crystal display device 1003 and is closer to the lyrics display area 1022 and the Roman letters display area 1023 in which information necessary to the player is displayed, in comparison to the second liquid crystal display device 1004 located above the first liquid crystal display device 1003, for a player whose line of sight is directed at the lyrics display area 1022 and the Roman letters display area 1023 for long periods during the game, by decreasing movement of eye line-of-sight, the PV (promotional video) footage 1020 can be seen, and buildup of eye fatigue, mental fatigue, and stress can be lessened.

From the above, when step S1022 is executed, the CPU 1051 and the display control circuit 1060 function as an “independent image area securing device”.

Furthermore, when step S1023 is executed, the CPU 1051 and the display control circuit 1060 function as “identical simultaneous display device”.

Moreover, there is no limitation to the abovementioned embodiment of the present invention, and diverse modifications that do not depart from the spirit and bounds thereof are possible.

For example, in the typing game machine 1 of the present embodiment, the first liquid crystal display device 3 on which the main game screen 21 is displayed when a typing game is being executed is disposed in the cabinet 2 so as to be positioned below the second liquid crystal display device 4 on which a presentation image 20, such as the promotional video or the like, is displayed; however, there is no limitation to this position-relationship mode, and, for example, the first liquid crystal display device 3 may be positioned above the second liquid crystal display device 4, or may be disposed at the same height, to the left or right thereof.

Additionally, the typing game machine 1 related to the present embodiment may be connected to a server 80 via a network N in which bi-directional communication is possible, such as the Internet or the like, and based on data transmitted from the server 80, music data stored on the HDD 55 (see FIG. 9) of the typing game machine 1 can be updated; however, a configuration is also possible in which music data can be updated independently of the server 80.

Moreover, there is no limitation to the abovementioned embodiment of the present invention, and diverse modifications that do not depart from the spirit and bounds thereof are possible.

For example, in the typing game machine 1001 of the present embodiment, the independent image area 1101, in which a video identical to the PV (promotional video) footage 1020 displayed on the second liquid crystal display device 1004 is displayed with the same timing, is arranged in the upper central region of the main game display 1021 on the first liquid crystal display device 1003. In this regard, there is no overlapping of the lyrics display area 1022, the Roman letters display area 1023, the music state display area 1025, the typing results display area 1026, the score display area 1027, and the song information display area 1028, inside the main game screen 1021, and if there is no interference with the typing game, the independent image area 1101 may be arranged outside of the upper central area of the main game screen 1021 on the first liquid crystal display device 1003, and there is no limitation to the size thereof.

In addition, unlike the typing game machine 1001 related to the present embodiment, in cases in which the frame of the main game screen 1021 does not coincide with the screen frame of the first liquid crystal display device 1003, and the frame of the main game screen 1021 is smaller than the screen frame of the first liquid crystal display device 1003, the independent image area 1101 may be arranged outside the frame of the main game screen 1021; and alternatively, without overlapping the lyrics display area 1022, the Roman letters display area 1023, the music state display area 1025, the typing results display area 1026, the score display area 1027, and the song information display area 1028, inside the main game screen 21, if there is no interference with the typing game, may be arranged inside the frame of the main game screen 1021 or overlapping the main game screen 1021.

Furthermore, the typing game machine 1001 related to the present embodiment has one of each of the first liquid crystal display device 1003 for displaying the main game screen 1021 in which the independent image area 1101 is arranged when a typing game is being executed, and the second liquid crystal display device 1004 for displaying the independent image area 1101 together with the presentation image such as the PV (promotional video) footage 1020 and the like. In this regard, if there is at least one of each, there may be two or more of either or both, and they may be disposed at any position in the cabinet 1002.

Furthermore, in the typing game machine 1001 related to the present embodiment, the first liquid crystal display device 1003, in which the main game screen 1021 is displayed during a typing game, is disposed in the cabinet 1002 so as to be below the second liquid crystal display device 1004 in which the presentation image, such as the PV (promotional video) footage 1020 and the like, is displayed; however, there is no limitation to this positional relationship mode, and, for example, the first liquid crystal display device 1003 may be positioned above the second liquid crystal display device 1004, or may be disposed at the same height, to the left or right thereof. In this regard, the second liquid crystal display device 1004 may be positioned below the first liquid crystal display device 1003, or furthermore, may be installed at the side of the cabinet 1002 or as a small sized monitor at a location separated from the cabinet 1002, such as at the entrance to the establishment or the like.

Furthermore, as a typing game apparatus related to the present invention, as described above, a cabinet-type typing game machine 1 installed in a game center or the like was cited and explained as an example; however, application is also possible to a typing game apparatus in which typing game software is installed in a PC having two display screens.

### INDUSTRIAL APPLICABILITY

The present invention is applicable to display technology for a typing game apparatus.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A typing game apparatus comprising:
an image display for displaying a prescribed image related to a game;
an input device on which a plurality of keys corresponding to a plurality of characters is disposed; and
a CPU for determining whether or not a character string inputted by the input device is in agreement with a prescribed character string and for controlling the game based on a determination result of the determining, wherein
the image display comprises a first display screen and a second display screen disposed above the first display screen.

2. The typing game apparatus according to claim 1, further comprising a display controller for displaying game information related to progress of the game, including the prescribed character string, on the first display screen, and for displaying a presentation image, in which an effect presentation for the game is performed in parallel with a display on the first display screen, on the second display screen.

3. The typing game apparatus according to claim 2, further comprising:
a memory for storing music data; and
a sound controller for performing music at a specified tempo and for outputting sound, based on the music data stored in the memory, wherein
the display controller displays a character string related to the sound output by the sound controller, as the prescribed character string, on the first display screen, and also displays a presentation image related to the music in accompaniment with progress of the music that is being performed by the sound controller, on the second display screen.

4. The typing game apparatus according to claim 3, wherein the presentation image related to the music is a promotional video.

5. The typing game apparatus according to claim 1, wherein
the display controller being provided for displaying game information related to progress of the game, including the prescribed character string, on the first display screen, and for displaying a presentation image, in which an effect presentation for the game is performed in parallel with a display on the first display screen, on the second display screen, the display controller secures an independent image area in the upper central region of the first display screen; and displays a presentation image identical to a presentation image displayed on the second display screen, simultaneously in the independent image area.

6. The typing game apparatus according to claim 5, further comprising:
a memory for storing music data; and
a sound controller for performing music at a specified tempo and for outputting sound, based on the music data stored in the memory; wherein
the display controller displays a character string related to the sound outputted by the sound controller, as the prescribed character string, on the first display screen, and also displays a presentation image related to the music in accompaniment with progress of the music that is being performed by the sound controller, on the second display screen.

7. The typing game apparatus according to claim 6, wherein the presentation image related to the music is a promotional video.
